(19) United States
(12) Patent Application Publication
(10) Pub. No.: US 2003/0107698 A1
(43) Pub. Date: Jun. 12, 2003

(54) Liquid crystal display device

(76) Inventors: Ikuko Nagayama, Chiba (JP); Atsumu Iguchi, Mobara (JP); Shigeo Nakamura, Mobara (JP); Hideki Nakagawa, Chiba (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/315,193

(22) Filed: Dec. 10, 2002

(30) Foreign Application Priority Data
Dec. 12, 2001 (JP) 2001-378028

(51) Int. Cl. G09G 3/36

(52) U.S. Cl. 349/149

(57) ABSTRACT

In a liquid crystal display device which forms pixels and a driving circuit on a same substrate, it is possible to realize the liquid crystal display device which can be easily assembled. A peripheral frame is formed such that the peripheral frame surrounds a display region on which the pixels are formed. The liquid crystal composition is held in the inside of the peripheral frame. A sealing material is filled into the outside of the peripheral frame with an equal width. Inside the peripheral frame, a driving circuit forming region is provided. A liquid crystal panel is housed in a package. A housing portion is closed by a light shielding frame. The light shielding frame is configured to also perform the light shielding of the driving circuit forming region in the inside of the peripheral frame.

### BACKGROUND OF THE INVENTION

The present invention relates to a liquid crystal display device, and more particularly to a technique which is effectively applicable to a driving-circuit incorporating liquid crystal display device which forms driving circuits and a display part on a same substrate.

A liquid crystal display device has been popularly used as a display terminal of a small-sized display device as well as a so-called OA (office automation) equipment. This liquid crystal display device constitutes a so-called liquid crystal panel (also referred to as a liquid crystal display element or a liquid crystal cell) by sandwiching a layer made of liquid crystal composition (a liquid crystal layer) between a pair of insulating substrates one of which is made of a transparent substrate (for example, a glass plate, a plastic substrate or the like).

This liquid crystal panel performs the pixel formation by changing the orientation direction of liquid crystal molecules constituting the liquid crystal composition of given pixel portions by selectively applying a voltage to various electrodes for forming pixels. Among liquid crystal panels, there has been known a liquid crystal panel in which pixels are arranged in a matrix array. The liquid crystal panel in which the pixels are arranged in a matrix array is roughly classified into two types consisting of a simple matrix type and an active matrix type. In the simple matrix type liquid crystal panel, each pixel is formed at a crossing point where two stripe-shaped electrodes which are respectively formed on a pair of insulating substrates cross each other. Further, in the active matrix type liquid crystal panel, pixel electrodes and active elements, (for example, thin film transistors) for selecting pixels are provided and by selecting these active elements, the pixels are formed by pixel electrodes which are connected to the active elements and reference electrodes which face the pixel electrodes in an opposed manner.

The active matrix type liquid crystal display device has been popularly used as a display device of a notebook type personal computer or the like. In general, the active matrix type liquid crystal display device adopts a so-called vertical electric field type in which an electric field for changing the orientation direction of a liquid crystal layer is applied between electrodes formed on one substrate and electrodes formed on another substrate. Further, a so-called horizontal electric field type (also referred to as IPS (In Plane Switching) type) liquid crystal display device which makes the direction of an electric field applied to a liquid crystal layer substantially parallel to a surface of the substrate has been commercialized.

Among display devices employing the liquid crystal display device, a liquid crystal projector has been practical use. The liquid crystal projector illuminates a liquid crystal display element with light from a light source and projects images on the liquid crystal display element on a screen. Two types, a reflective type liquid crystal display element is capable of being configured to make approximately the entire pixel area a useful reflective area, and consequently it has advantages of its small size, high definition display and high luminance over the transmissive type liquid crystal display element.

Consequently, a small-sized high-definition liquid crystal projector can be realized by using the reflective liquid crystal display element without decreasing its luminance.

Further, as the active matrix type liquid crystal display device for liquid crystal projector, there has been known a so-called driving circuit incorporating liquid crystal display device which also forms driving circuits for driving pixel electrodes on a substrate on which pixel electrodes are formed in view of an advantage that a miniaturized and high-definition liquid crystal display device can be realized.

Still further, with respect to the driving circuit incorporating liquid crystal display device, there has been known a reflective type liquid crystal display device which forms pixel electrodes and driving circuits on a semiconductor substrate in place of an insulating substrate (Liquid Crystal on Silicon, also referred to as LCOS hereinafter).

With respect to the driving circuit incorporating liquid crystal display device, to realize the miniaturization, to enhance the definition and to increase gray scale level of the liquid crystal display device, the size of the driving circuits is increased to the contrary. Further, as a method for supplying a gray scale voltage to the pixel electrodes, a so-called digital-analogue conversion (also referred to a D/A conversion hereinafter) which selects the gray scale voltage from values of display data which are digital data may be used. However, in this case, a problem that along with the progress of the multiple gray scale, the bit number of the display data is increased and the size of the circuits is also increased accordingly becomes apparent.

Further, along with the increase of the size of the circuit, the area that the driving circuits occupy is increased and this necessitates the review of positions where the driving circuits are arranged.

Further, along with the increase of the size of the circuits, it is necessary to review a packaging method for miniaturizing the liquid crystal display device.

### SUMMARY OF INVENTION

In a liquid crystal panel which forms a driving circuit for driving pixels on a same substrate having a display region in which the pixels are formed, a peripheral frame in which liquid crystal composition is held is provided, and a region in which the driving circuit is formed is also provided in an inner region of the peripheral frame.

Further, the region in which the driving circuit is formed in the inside of the peripheral frame is provided with a light shielding frame to prevent the observation from the outside.

### BRIEF DESCRIPTION OF THE DRAWINGS

FIG. 1 is a block diagram showing a schematic constitution of a liquid crystal display device according to one embodiment of the present invention.

FIG. 2 is a block diagram showing a layout of circuits in the periphery of a display part of the liquid crystal display device according to one embodiment of the present invention.

FIG. 3 is a block diagram showing a layout of circuits in the periphery of a display part of the liquid crystal display device according to one embodiment of the present invention.

FIG. 4 is a block diagram showing a layout of circuits in the periphery of a display part and a sealing material coating region of the liquid crystal display device according to one embodiment of the present invention.

FIG. 5 is a block diagram showing the circuit constitution of the liquid crystal display device according to one embodiment of the present invention.

FIG. 6 is a schematic circuit diagram for explaining of a manner for controlling a pixel potential.

FIG. 7 is a schematic circuit diagram showing the constitution of a pixel potential control circuit.

FIG. 8 is a schematic circuit diagram showing the constitution of an inspection scanning circuit.

FIG. 9 is a circuit diagram showing the schematic constitution of a voltage selecting circuit of a liquid crystal display device according to one embodiment of the present invention.

FIG. 10 is a circuit diagram showing the schematic constitution of a voltage selecting circuit of a liquid crystal display device according to one embodiment of the present invention.

FIG. 11 is a timing waveform chart for explaining the operation of the liquid crystal display device according to one embodiment of the present invention.

FIG. 12 is a timing waveform chart for explaining the operation of the liquid crystal display device according to one embodiment of the present invention.

FIG. 13 is a schematic view for explaining one embodiment of the liquid crystal display device according to the present invention.

FIG. 14 is a schematic plan view of a display part for explaining one embodiment of the liquid crystal display device according to the present invention.

FIG. 15 is a schematic plan view of a display part including dummy pixels for explaining one embodiment of the liquid crystal display device according to the present invention.

FIG. 16 is a block diagram showing a layout of circuits in the periphery of a display part of the liquid crystal display device according to one embodiment of the present invention.

FIG. 17 is a block diagram showing a layout of circuits in the periphery of a display part and a sealing material coating region of the liquid crystal display device according to another embodiment of the present invention.

FIG. 18 is a block diagram showing a layout of circuits in the periphery of a display part and a sealing material coating region of the liquid crystal display device according to still another embodiment of the present invention.

FIG. 19 is a schematic cross-sectional view showing the constitution of a pixel portion of the liquid crystal display device according to the present invention.

FIG. 20 is a schematic plan view showing the constitution of a pixel portion of the liquid crystal display device according to the present invention.

FIG. 21 is a schematic cross-sectional view of the periphery of an active element for explaining one embodiment of the liquid crystal display device according to the present invention.

FIG. 22 is a schematic plan view of the periphery of an active element for explaining one embodiment of the liquid crystal display device according to the present invention.

FIG. 23 is a schematic assembled view of the liquid crystal display device according to the present invention.

FIG. 24 is a schematic view showing a state in which a flexible printed wiring board is connected to a liquid crystal panel of the liquid crystal display device constituting one embodiment of the present invention.

FIG. 25 is a schematic assembled view of the liquid crystal display device according to the present invention.

FIG. 26 is a schematic view showing the liquid crystal display device constituting one embodiment of the present invention.

FIG. 27 is a schematic view showing a state in which a flexible printed wiring board is connected to a liquid crystal panel of the liquid crystal display device constituting one embodiment of the present invention.

FIG. 28 is a schematic assembled view of the liquid crystal display device according to the present invention.

FIG. 29 is a schematic cross-sectional view of the liquid crystal panel according to the present invention.

FIG. 30 is a schematic view showing the liquid crystal display device which constitutes one embodiment of the present invention.

FIG. 31 is a partially enlarged view of a light shielding frame of the liquid crystal display device according to the present invention.

FIG. 32 is a schematic view showing the liquid crystal display device which constitutes one embodiment of the present invention.

FIG. 33 is a schematic view showing the liquid crystal display device which constitutes one embodiment of the present invention.

FIG. 34 is a schematic view showing the liquid crystal display device which constitutes one embodiment of the present invention.

FIG. 35 is a schematic view showing the liquid crystal display device which constitutes one embodiment of the present invention.

### DETAILED DESCRIPTION OF THE PREFERRED EMBODIMENTS

Preferred embodiments of the present invention are explained in detail hereinafter in conjunction with drawings.

In all drawings for explaining the embodiments of the present invention, parts having identical functions are given same numerals and the repeated explanation of the parts is omitted.

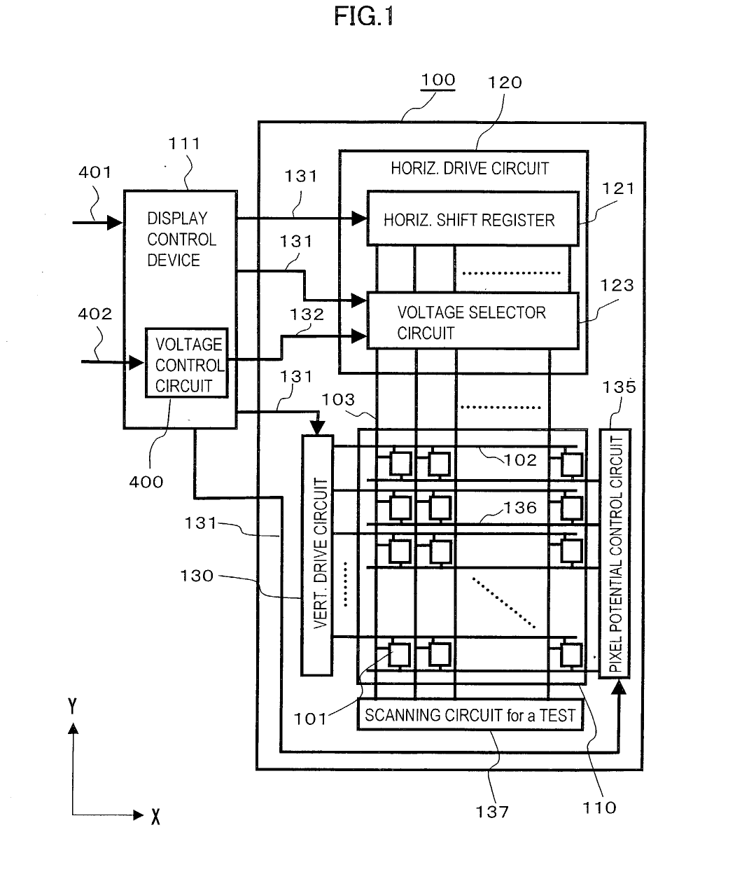

FIG. 1 is a block diagram showing the schematic constitution of a liquid crystal display device according to one embodiment of the present invention.

The liquid crystal display device according to the present invention is constituted of a liquid crystal panel (liquid crystal display element) 100 and a display control device 111. The liquid crystal panel 100 includes a display part 110 on which pixel portions 101 are formed in a matrix array, a horizontal driving circuit (video signal line driving circuit) 120, a vertical driving circuit (scanning signal line driving circuit) 130, a pixel potential control circuit 135 and an inspection scanning circuit 137. Further, the display part 110, the horizontal driving circuit 120, the vertical driving circuit 130, the pixel potential control circuit 135 and the inspection scanning circuit 137 are formed on the same substrate. In the pixel portions 101, pixel electrodes, counter electrode and a liquid crystal layer which is sandwiched by both electrodes are provided (not shown in the drawing). A display is performed by making use of a phenomenon that by applying a voltage between the pixel electrodes and the counter electrodes, the orientation direction of liquid crystal molecules or the like is changed and the property of the liquid crystal layer with respect to light is changed corresponding to the change of the orientation direction of the liquid crystal molecules.

As described above, although the display part 110, the horizontal driving circuit 120, the vertical driving circuit 130, the pixel potential control circuit 135 and the inspection scanning circuit 137 are formed on the same substrate, when the area which is occupied by the driving circuits such as the horizontal driving circuit 120, the vertical driving circuit 130, the pixel potential control circuit 135, the inspection scanning circuit 137 and the like is increased with respect to the display part 110, there arises a problem that the area where a display is not performed is increased with respect to the area where the display is performed.

Although the present invention is effectively applicable to the liquid crystal display device having the pixel potential control circuit 135, it is not limited to the liquid crystal display device having the pixel potential control circuit 135. Further, although the present invention is effectively applicable to the liquid crystal display device having the inspection scanning circuit 137, it is not limited to the liquid crystal display device having the inspection scanning circuit 137.

An external control signal line 401 extended from an external device (for example, a personal computer or the like) is connected to the display control device 111. Using control signals such as clock signals, display timing signals, horizontal synchronous signals, vertical synchronous signals and the like which are transmitted to the display control device 111 from the outside through the external control signal line 401, the display control device 111 outputs the signals for controlling the horizontal driving circuit 120, the vertical driving circuit 130 and the pixel potential control circuit 135.

Further, the display control device 111 includes a video signal control circuit 400. A display signal line 402 is connected to the video signal control circuit 400 so that display signals are inputted to the video signal control circuit 400 from an external device. The display signals are transmitted in a fixed sequence or order such that they form images on the liquid crystal panel 100. For example, pixel data corresponding to one line is sequentially transmitted headed by the pixel which is positioned at a left upper portion of the liquid crystal panel 100, and data of respective lines are sequentially transmitted from the external device from a top portion to a bottom portion of the liquid crystal panel 100. The video signal control circuit 400 forms video signals based on the display signals and supplies the video signals to the horizontal driving circuit 120 matching the timing that the liquid crystal panel 100 displays the image.

Numeral 131 indicates a control signal line outputted from the display control device 111 and numeral 132 indicates a video signal transmitting line. The video signal transmitting line 132 is outputted from the display control device 111 and is connected to the horizontal driving circuit 120 provided to a periphery of the display part 110. A plurality of video signal lines (also referred to as drain signal lines or vertical signal lines) 103 are extended in the vertical direction (Y direction in the drawing) from the horizontal driving circuit 120. Further, a plurality of video signal lines 103 are arranged in parallel in the horizontal direction (X direction). The video signals are transmitted to the pixel portions 101 through the video signal lines 103.

Further, the vertical driving circuit 130 is also provided to the periphery of the display part 110. A plurality of scanning signal lines (also referred to as gate signal lines or horizontal signal lines) 102 are extended in the horizontal direction (X direction) from the vertical driving circuit 130. Further, the plurality of scanning signal lines 102 are arranged in parallel in the vertical direction (Y direction). Scanning signals which are served for turning on or off the switching elements provided to the pixel portions 101 are transmitted through the scanning signal lines 102.

Further, the pixel potential control circuit 135 is provided to the periphery of the display part 110. A plurality of pixel potential control lines 136 are extended in the horizontal direction (X direction) from the pixel potential control circuit 135. Further, a plurality of pixel potential control lines 136 are arranged in parallel in the vertical direction (Y direction). Signals which are served for controlling the potential of the pixel electrodes are transmitted through the pixel potential control lines 136.

Further, the inspection scanning circuit 137 is provided to the periphery of the display part 110. The above-mentioned video signal lines 103 are connected to the inspection scanning circuit 137 and signals for inspection can be outputted to the video signal lines 103.

The horizontal driving circuit 120 includes a horizontal shift register 121 and a video signal selecting circuit 123. The control signal lines 131 and the video signal transmitting lines 132 which are outputted from the display control device 111 are connected to the horizontal shift register 121 and the video signal selecting circuit 123 so that the control signals and the video signals are transmitted to the horizontal shift register 121 and the videos signal selecting circuit 123. Here, although the indication of power supply voltage lines for respective circuits is omitted, it is assumed that necessary voltages are supplied to respective circuits.

When the first display timing signal is inputted to the display control device 111 after inputting of the vertical synchronous signal from the outside, the display control device 111 outputs a start pulse to the vertical driving circuit 130 through the control signal line 131. Subsequently, based on the horizontal synchronous signal, the display control device 111 outputs a shift clock to the vertical driving circuit 130 such that the scanning signal lines 102 are sequentially selected every one horizontal scanning time (indicated by 1 h hereinafter). The vertical driving circuit 130 selects the scanning signal lines 102 in accordance with the shift clocks and outputs the scanning signals to the scanning signal lines 102. That is, the vertical driving circuit 130 outputs signals for selecting the scanning signal lines 102 sequentially from the top portion in FIG. 1 during one horizontal scanning time 1 h.

Further, when the display timing signal is inputted, the display control device 111 determines this inputting as starting of display and outputs the video signals to the horizontal driving circuit 120. Although the video signals are sequentially outputted from the display control device 111, the horizontal shift register 121 outputs timing signals in accordance with the shift clocks transmitted from the display control device 111. The timing signals indicate the timing for fetching the video signals to be outputted from the video signal selecting circuit 123 to respective video signal lines 102.

When the video signals are analogue signals, the video signal selecting circuit 123 includes a circuit (sample holding circuit) which fetches and holds the video signal for every video signal line 103 and this sample holding circuit fetches the video signal when the timing signal is inputted. The display control device 111 outputs the video signals to be fetched by the sample holding circuit at the timing that the timing signal is inputted to the specific sample holding circuit. The video signal selecting circuit 123 fetches a fixed voltage as the video signal (gray scale voltage) from analogue signals in accordance with the timing signal and outputs the fetched video signal to the video signal line 103. The video signal which is outputted to the video signal line 103 is written in the pixel electrodes of the pixel portions 101 in accordance with timing that the scanning signals are outputted from the vertical driving circuit 130.

Here, with respect to analogue signals, it is possible to adopt a method in which the video signals are developed in a plurality of phases and are outputted to the video signal selecting circuit 123 from the display control device 111 so as to provide a margin to the sample holding circuit with respect to a period for fetching the video signals.

Subsequently, when the video signals are digital signals, digital data which indicates the gray scale voltage to be outputted to respective video signal lines 103 is outputted from the display control device 111 and the video signal selecting circuit 123 records the video signals in conformity with the timing signal. Thereafter, the gray scale voltage to be outputted to the video signal line 103 is selected and is outputted in accordance with the values of the video signals. The video signal selecting circuit 123 has a function of a so-called digital-analogue conversion circuit and hence, there exists a problem that when the number of gray scale is increased, the number of digital signals is increased so that the size of the circuit is enlarged.

The pixel potential control circuit 135 controls the voltage of the video signals written in the pixel electrodes in response to the control signals transmitted from the display control device 111. The gray scale voltage written in the pixel electrodes through the video signal lines 103 has a certain potential difference with respect to the reference voltage of the counter electrodes. The pixel potential control circuit 135 supplies the control signals to the pixel portions 101 and changes the potential difference between the pixel electrodes and the counter electrodes. The pixel potential control circuit 135 is described in detail later.

The inspection scanning circuit 137 is a circuit served for inspecting whether the liquid crystal panel 100 has a defect or not by checking the operation of the liquid crystal panel 100 in a state of a chip or a wafer. By providing the inspection scanning circuit 137 over the liquid crystal panel 100, it is possible to input signals for inspection to the liquid crystal panel 100 and to take out the inputted signals to the outside for inspection. The inspection scanning circuit 137 is also described in detail later.

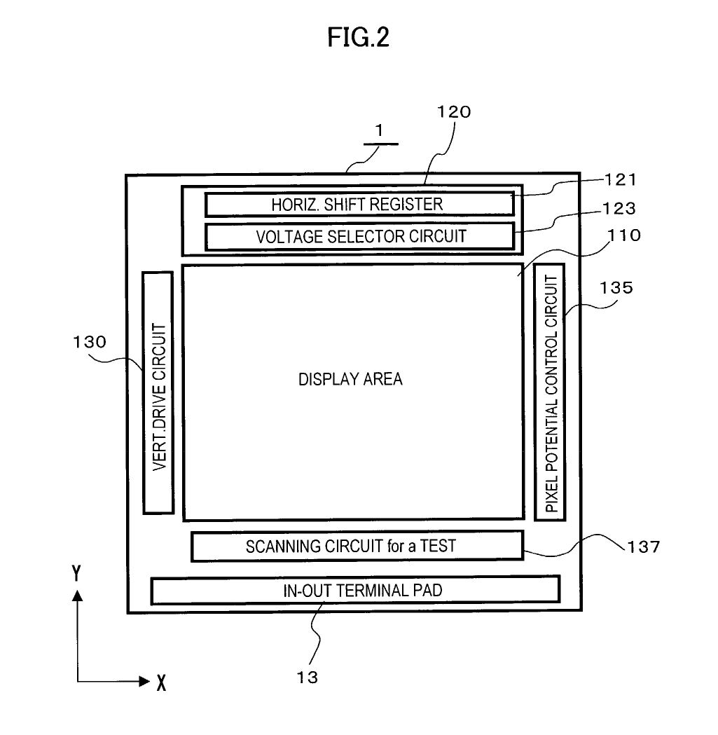

Subsequently, the layout in the periphery of the display part 110 of the liquid crystal display device is explained in conjunction with FIG. 2. FIG. 2 is a schematic block diagram of the substrate 1 on which the display part 110 is mounted. Although, the substrate 1 is formed of a silicon substrate as described in detail later and the circuits are formed on the substrate 1 by a semiconductor process. Here, FIG. 2 shows the layout of respective circuits and the like. To facilitate the understanding of the drawing, the signal lines, the liquid crystal layer and the like are omitted.

In the drawing, the vertical driving circuit 130 and the pixel potential control circuit 135 are arranged at left and right sides (in the X direction in the drawing) of the display part 110. Further, the horizontal driving circuit 120 and the inspecting scanning circuit 137 are arranged at upper and lower sides (in the Y direction in the drawing) of the display part 110. Among these respective circuits, the horizontal driving circuit 120 is liable to be slightly larger than other circuits. However, by arranging respective circuits at four sides of the display part 110, it is possible to provide a substantially same gap between the display part 110 and end sides of the substrate 1.

An inputting/outputting terminal pad part 13 is a region provided for mounting terminals for inputting and outputting signals to and from the liquid crystal panel 100. It is necessary to provide regions on which wiring connecting the inputting/outputting terminal pad part 13 with respective circuit are mounted and hence, wiring regions having given widths are formed. Although the inputting/outputting terminal pad part 13 is formed at the inspection scanning circuit 137 side in FIG. 2, it is also effective to provide the inputting/outputting terminal pad part 13 at the horizontal driving circuit 120 side, taking the length of pull-around wiring into consideration.

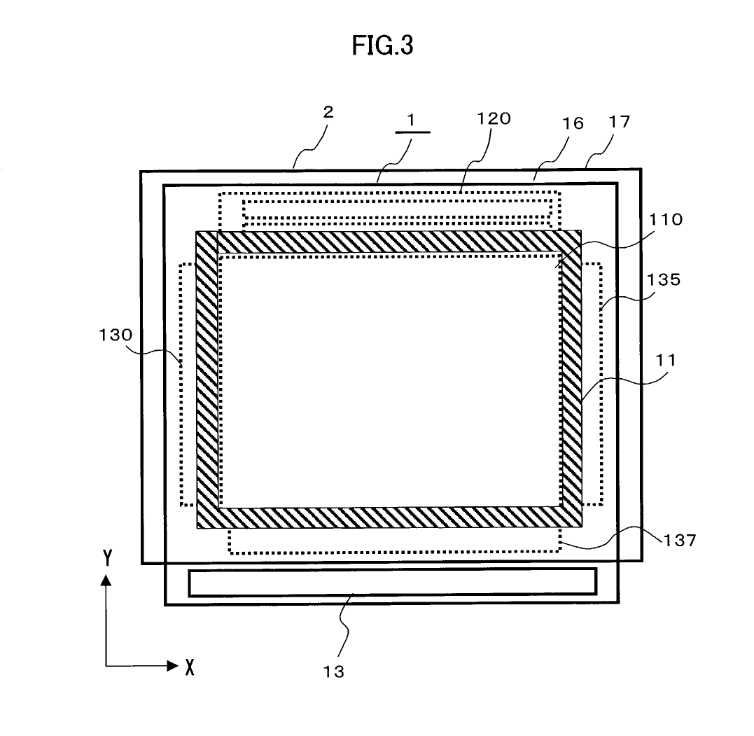

Subsequently, a state in which the substrate 1 and a transparent substrate 2 are combined is shown in FIG. 3. The transparent substrate 2 is a transparent substrate made of glass, resin or the like. Numeral 11 indicates a peripheral frame. The transparent substrate 2 and the substrate 1 are combined while sandwiching the peripheral frame 11 therebetween thus forming the liquid crystal panel 100. The peripheral frame 11 is formed in the periphery of the display part 110. Liquid crystal composition is held in the inside surrounded by the substrate 1, the transparent substrate 2 and the peripheral frame 11. The peripheral frame 11 will be described in detail later. Numeral 16 indicates an outer periphery of the substrate 1 and numeral 17 indicates an outer periphery of the transparent substrate 2.

In FIG. 3, the vertical driving circuit 130, the pixel potential control circuit 135, the horizontal driving circuit 120 and the inspection scanning circuit 137 are shown by a dotted line. Although a surface of the substrate 1 is covered with a light shielding film so that these circuits are not observed from outside in an actual liquid crystal panel, these circuits are indicated by the dotted line in FIG. 3 to show their positional relationship with the peripheral frame 11. As mentioned previously, respective circuits are formed in the periphery of the display part 110 and hence, the peripheral frame 11 is formed such that the peripheral frame 11 partially overlaps respective circuits. Outside the peripheral frame 11, a gap is formed between the substrate 1 and the transparent substrate 2. A sealing material is filled in the gap.

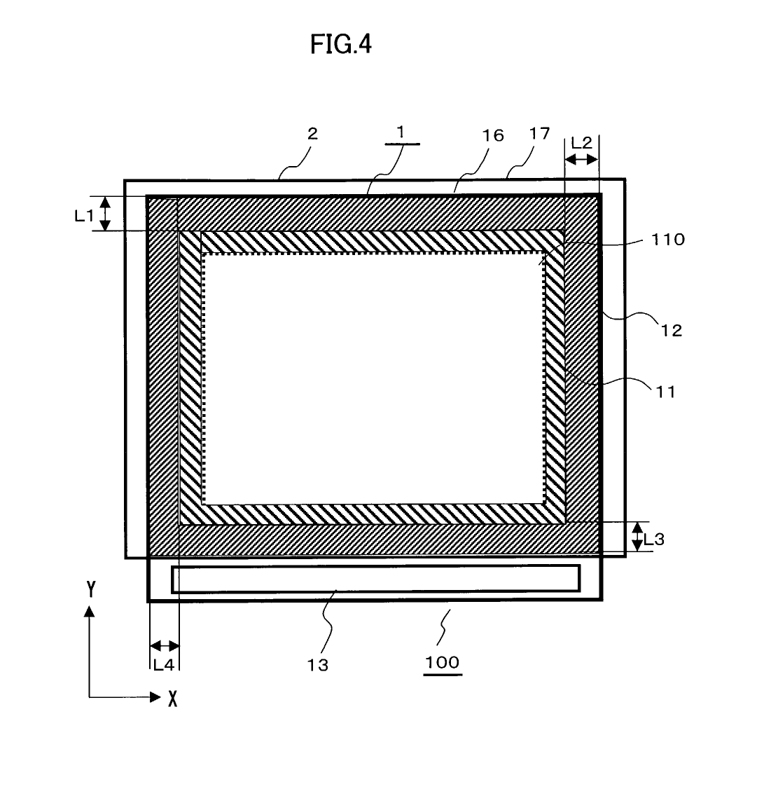

FIG. 4 shows a state in which the sealing material 12 is filled in the gap. In the drawing, at the upper side of the display part 110, the sealing material 12 is filled in the gap such that the sealing material 12 extends from the outside of the peripheral frame 11 to the outer periphery 16 of the substrate 1. Further, at the lower side of the display part 110, the sealing material 12 is filled in the gap such that the sealing material 12 extends from the outside of the peripheral frame 11 to the outer periphery 17 of the transparent substrate 2. With respect to the region which is filled with the sealing material 12, the region overlaps with a region where the horizontal driving circuit 120 is formed at the upper side of the display part 110, and overlaps with a region where the inspection scanning circuit 137 is formed at the lower side of the display part 110. By providing the horizontal driving circuit 120 and the inspection scanning circuit 137 at positions above and below the display part 110, a width L1 and a width L3 of respective regions where the sealing material 12 is formed are set to a substantially equal length. In the same manner, the sealing material 12 is provided at left and right opposing sides while sandwiching the display part 110 therebetween. Here, since the vertical driving circuit 130 and the pixel potential control circuit 135 are respectively formed on these sides, a width L2 and a width L4 of respective regions where the sealing material 12 is formed are set to a substantially equal length.

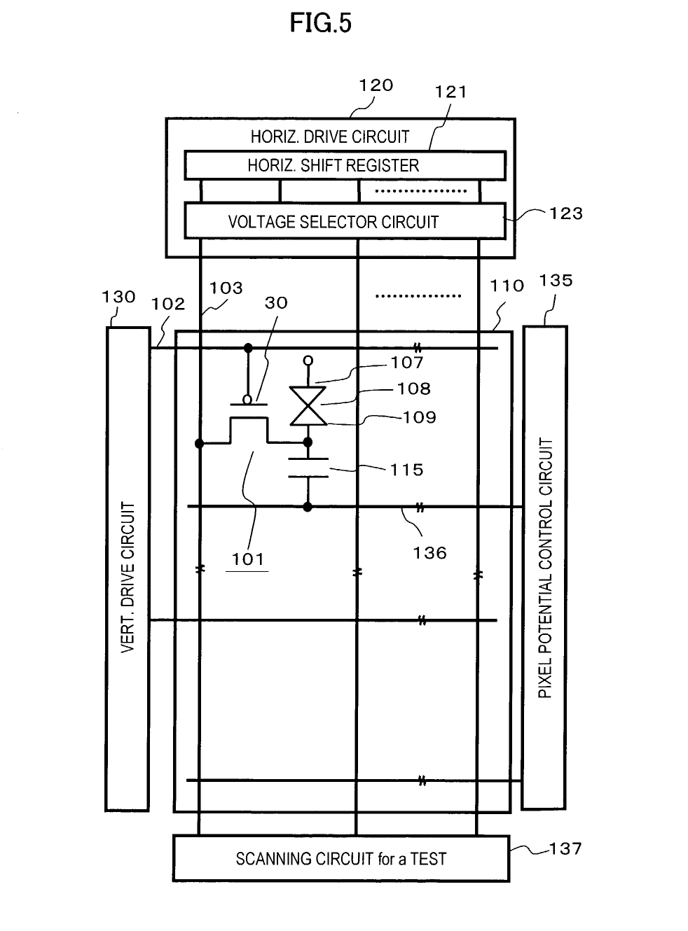

Then, the pixel portions 101 are explained in conjunction with FIG. 5. Further., the pixel potential control circuit 135 and the inspection scanning circuit 137 which are provided in the periphery of the display part 110 are explained also in conjunction with FIG. 5. FIG. 5 is a circuit diagram showing an equivalent circuit of the pixel portion 101. The pixel portions 101 are arranged in a matrix array in the display part 110, wherein each pixel portion 101 is arranged at a crossing region of two neighboring scanning signal lines 102 and two neighboring video signal lines 103 (a region surrounded by four signal lines). However, to simplify the drawing for clarification, only one pixel portion 101 is shown in FIG. 5. Each pixel portion 101 includes an active element 30 and a pixel electrode 109. Further, a pixel capacitance 115 is connected to the pixel electrode 109. The pixel capacitance 115 has one electrode thereof connected to the pixel electrode 109 and the other electrode connected to the pixel potential control line 136. On the other hand, the pixel potential control line 136 is connected to the pixel potential control circuit 135. In FIG. 5, the active element 30 is constituted of a p-type transistor.

As mentioned previously, the scanning signal is outputted to the scanning signal lines 102 from the vertical driving circuit 130. The ON-OFF control of the active elements 30 is performed in response to this scanning signal. The gray scale voltage is supplied to the video signal lines 103 as the video signal. When the active element 30 is turned on, the gray scale voltage is supplied to the pixel electrode 109 through the video signal line 103. The counter electrodes (common electrode) 107 are arranged to face the pixel electrodes 109 in an opposed manner and a liquid crystal layer (not shown in the drawing) is formed between the pixel electrodes 109 and the counter electrodes 107. On the circuit diagram shown in FIG. 5, it is depicted that a liquid crystal capacitance 108 is equivalently connected between the pixel electrode 109 and the counter electrode 107. By applying a voltage between the pixel electrodes 109 and the counter electrodes 107, the orientation direction or the like of the liquid crystal molecules is changed. The display is performed by making use of a phenomenon that the nature of the liquid crystal layer with respect to light is changed in response to such a change of the orientation direction or the like of the liquid crystal molecules.

As a driving method of the liquid crystal display device, an AC driving which obviates applying of DC current to the liquid crystal layer is performed. To perform the AC driving, when the potential of the counter electrodes 107 is used as the reference potential, the voltage having positive polarity and the negative polarity with respect to the reference voltage is outputted as the gray scale voltage from the video signal selecting circuit 123. However, when the video signal selecting circuit 123 is constituted of a high withstand voltage circuit which can withstand the potential difference between the positive polarity and the negative polarity, there arises a problem that the size of the circuit including the active elements 30 becomes large or a problem that the operation speed becomes slow.

Accordingly, the inventors of the present invention have reviewed the possibility of performing the AC driving using the signal having the same polarity with respect to the reference potential as the video signal to be supplied to the pixel electrodes 109 from the video signal selecting circuit 123. For example, as the gray scale voltage outputted from the video signal selecting circuit 123, the voltage having positive polarity with respect to the reference potential is used. Then, after the voltage having positive polarity with respect to the reference potential is written in the pixel electrodes, the voltage of the pixel potential control signal applied to the electrodes of the pixel capacitances 115 is lowered so as to lower the voltage of the pixel electrodes 109 whereby the voltage having negative polarity with respect to the reference potential is generated. By adopting such a driving method, the difference between the maximum value voltage and the minimum value voltage which the video signal selecting circuit 123 outputs becomes small and hence, it is possible to use a low withstand voltage circuit as the video signal selecting circuit 123. Here, although a case in which the voltage having positive polarity is written in the pixel electrodes 109 so as to make the pixel potential control circuit 135 generate the voltage of the negative polarity is explained as the example, when the voltage having positive polarity is to be generated by writing the voltage of negative polarity, this can be achieved by increasing the voltage of the pixel potential control signal.

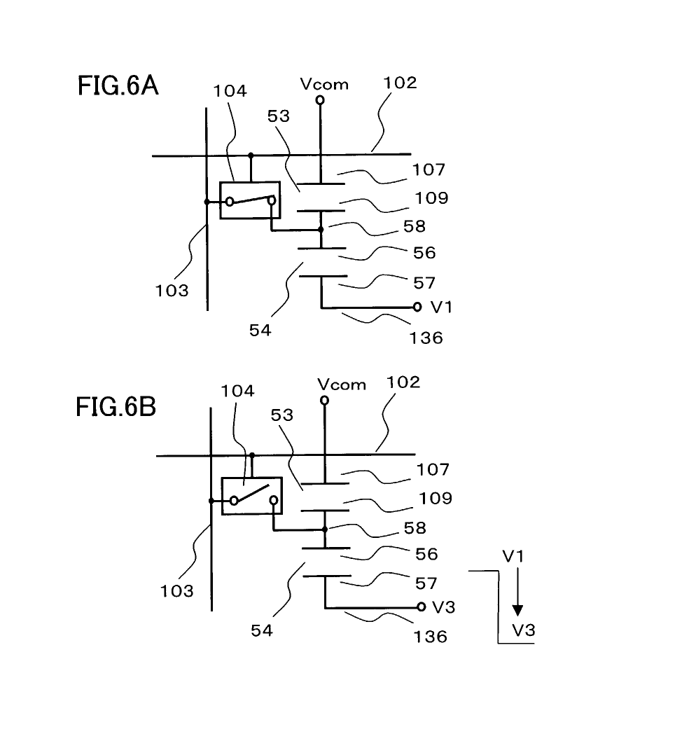

Subsequently, a method for changing the voltage of the pixel electrode 109 is explained in conjunction with FIG. 6. In FIG. 6, for the sake of explanation, the liquid crystal capacitance 108 is expressed as a first capacitor 53, the pixel capacitance 115 is expressed as a second capacitor 54, and the active element 30 is expressed as a switch 104. Further, the electrode of the pixel capacitance 115 which is connected to the pixel electrode 109 is expressed as an electrode 56 and the electrode of the pixel capacitance 115 which is connected to the pixel potential control line 136 is expressed as an electrode 57. Further, a point where the pixel electrode 109 and the electrode 56 are connected is expressed as a node 58. Here, for the sake of explanation, while ignoring other parasitic capacitances, the capacitance of the first capacitor 53 is expressed as CL and the capacitance of the second capacitor 54 is expressed as CC.

First of all, as shown in FIG. 6A, a voltage V1 is applied to the electrode 57 of the second capacitor 54 from the outside. Subsequently, when the switch 104 is turned on in response to the scanning signal, a voltage is supplied to the pixel electrode 109 and the electrode 56 from the video signal line 103. Here, a voltage supplied to the node 58 is set to V2.

Then, as shown in FIG. 6B, at a point of time that the switch 104 is turned off, the voltage (pixel potential control signal) supplied to the electrode 57 is dropped from V1 to V3. Here, since the total amount of electric charges stored in the first and second capacitors 53 and 54 remains unchanged, the voltage of the node 58 is changed. That is, the voltage of the node 58 becomes as follows. V2−{CC/(CL+CC)}×(V1−V3)

Here, when the capacitance CL of the first capacitor 53 is sufficiently small compared to the capacitance CC of the second capacitor 54 (CL<<CC), an equation CC/(CL+CC)≅1 is established so that the voltage of the node 58 is expressed by V2−V1+V3. Here, assuming V2 and V3 as V2=0, V3=0, the voltage of the node 58 becomes −V1.

According to the above-mentioned method, by making the voltage supplied to the pixel electrode 109 from the video signal line 103 have the positive polarity with respect to the reference potential of the counter electrode 107, it is possible to generate the signal of negative polarity by controlling the voltage (pixel potential control signal) applied to the electrode 57. By generating the signal having negative polarity in such a manner, it is unnecessary to supply the signal having negative polarity from the video signal selecting circuit 123 and hence, it is possible to form the peripheral circuit using components of low withstand voltage.

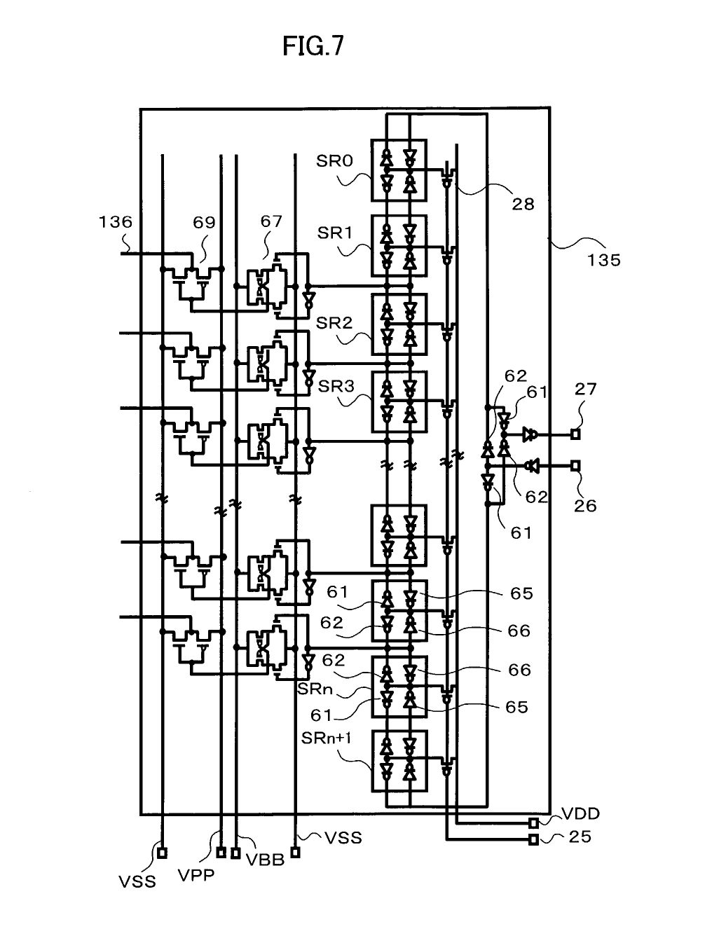

Subsequently, the circuit constitution of the pixel potential control circuit 135 is explained in conjunction with FIG. 7. Symbol SR indicates a two-way shift register which is capable of shifting the signal in two ways, that is, upwardly and downwardly. The two-way shift register SR is constituted of clocked inverters 61, 62, 65, 66. Numeral 67 indicates a level shifter and numeral 69 indicates an outputting circuit. The two-way shift register SR and the like are operated using a power supply voltage VDD. The level shifter 67 converts the voltage level of the signal outputted from the two-way shift register SR. From the level shifter 67, a signal having an amplitude between the power supply voltage VBB which assumes a potential higher than the power supply voltage VDD and the power supply voltage VSS (GND potential) is outputted. The power supply voltages VPP and VSS are supplied to the outputting circuit 69 and the outputting circuit 69 outputs the voltages VPP and VSS to the pixel potential control line 136 in accordance with a signal from the level shifter 67. When the voltage V1 of the above-mentioned pixel potential control signal assumes the power supply voltage VPP, the voltage V3 assumes the power supply voltage VSS. Here, in FIG. 7, the output circuit 69 is constituted of an inverter which is constituted of a p-type transistor and a n-type transistor. By selecting the power supply voltage VPP supplied to the p-type transistor and the power supply voltage VSS supplied to the n-type transistor, it is possible to output the voltages VPP, VSS as the pixel potential control signals.

However, since a substrate voltage is supplied to a silicon substrate which constitutes the p-type transistor, the value of the power supply voltage VPP is set to a proper value with respect to the substrate voltage.

In FIG. 7, numeral 26 indicates a start signal inputting terminal which supplies a start signal constituting one of control signals to the pixel potential control circuit 135. When the start signal is inputted, the two-way shift registers SR1 to SRn sequentially output timing signals in accordance with the timing of clock signals supplied from the outside. The level shifter 67 outputs the voltage VSS and the voltage VBB to the pixel potential control line 136 in accordance with the timing signal. The output circuit 69 outputs the voltage VPP and VSS to the pixel potential control line 136 in accordance with the output of the level shifter 67. By supplying the start signal and the clock signal to the two-way shift register SR so as to match the timing of the pixel potential control signal, it is possible to output the pixel potential control signal from the pixel potential control circuit 135 at the desired timing. In FIG. 7, numeral 25 indicates a reset signal inputting terminal.

The two-way shift register SR is constituted of clocked inverters and is capable of sequentially outputting the timing signals. Further, by constituting the pixel potential control circuit 135 using the two-way shift register SR, it is possible to scan the pixel potential control signals in two ways. That is, the vertical driving circuit 130 is also constituted of a similar two-way shift register and hence, the liquid crystal display device according to the present invention is capable of performing the vertical two-way scanning. Accordingly, when the displaying image is to be inverted up side down, the scanning direction is inverted so that the scanning is performed from the bottom to the top in the drawing. Here, when the vertical driving circuit 130 performs the scanning from the bottom to the top in the drawing, the pixel potential control circuit 135 is also configured to perform the scanning from the bottom to the top in the drawing correspondingly. Here, the horizontal shift register 121 and the inspection scanning circuit are also constituted of a two-way shift register in the same manner.

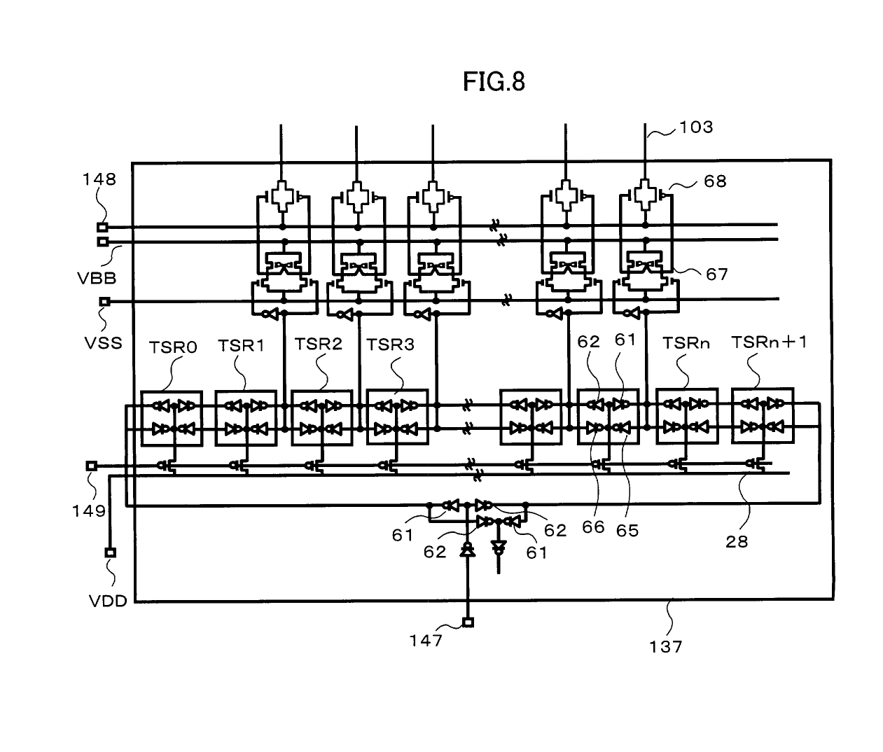

Subsequently, the inspection scanning circuit 137 is explained in conjunction with FIG. 8. The inspection scanning circuit 137 has a function of selecting the video signal line 103 and connecting the selected video signal line 103 with an inspection signal inputting/outputting terminal 148. The inspection scanning circuit 137 has a two-way shift register TSR and outputs a timing signal which makes an analogue switch 68 assume an ON state in synchronism with a clock signal inputted from an inspection clock terminal 147. Numeral 67 indicates a level shifter circuit which converts a voltage level of the timing signal to a voltage level which drives the analogue switch 68. Numeral 149 indicates an inspection resetting terminal to which a signal which resets the two-way shift register TSR is inputted.

When the analogue switch 68 assumes the ON state, the video signal line 103 and the inspection signal inputting/outputting terminal 148 are electrically connected to each other and hence, it is possible to input the inspection signal from the inspection signal inputting/outputting terminal 148 to the video signal line 103 and to read out the signal from the video signal line 103 to the inspection signal inputting/outputting terminal 148.

With the use of the inspection scanning circuit 137, it is possible to inspect the liquid crystal panel 100 in a state of a wafer or a chip before completing the liquid crystal panel 100. For example, the vertical scanning circuit 130 shown in FIG. 5 is operated so as to make the active element 30 assume the ON state, that is, the state in which the active element 30 can write the signal to the pixel electrode 109, while the inspection scanning circuit 137 is made to output the inspection signal to the video signal line 103. By increasing or decreasing the voltage of the inspection signal and by monitoring the current values brought about by the increase or the decrease of the voltage, it is possible to inspect the short-circuiting or the disconnection in the inside of the liquid crystal panel 100 and the performance of the active element.

As has been explained above, by arranging circuits such as the pixel potential control circuit 135, the inspection scanning circuit 137 and the like on the periphery of the display part 110 besides the horizontal scanning circuit 120 and the vertical scanning circuit 130, it is possible to uniformly provide regions where the sealing material 12 is filled at four sides of the display part 110. However, when a digital-analogue converting circuit is used as the horizontal driving circuit 120, there arises a problem that the size of the horizontal driving circuit 120 becomes large and hence, it is difficult to uniformly arrange the regions where the sealing material 12 is filled.

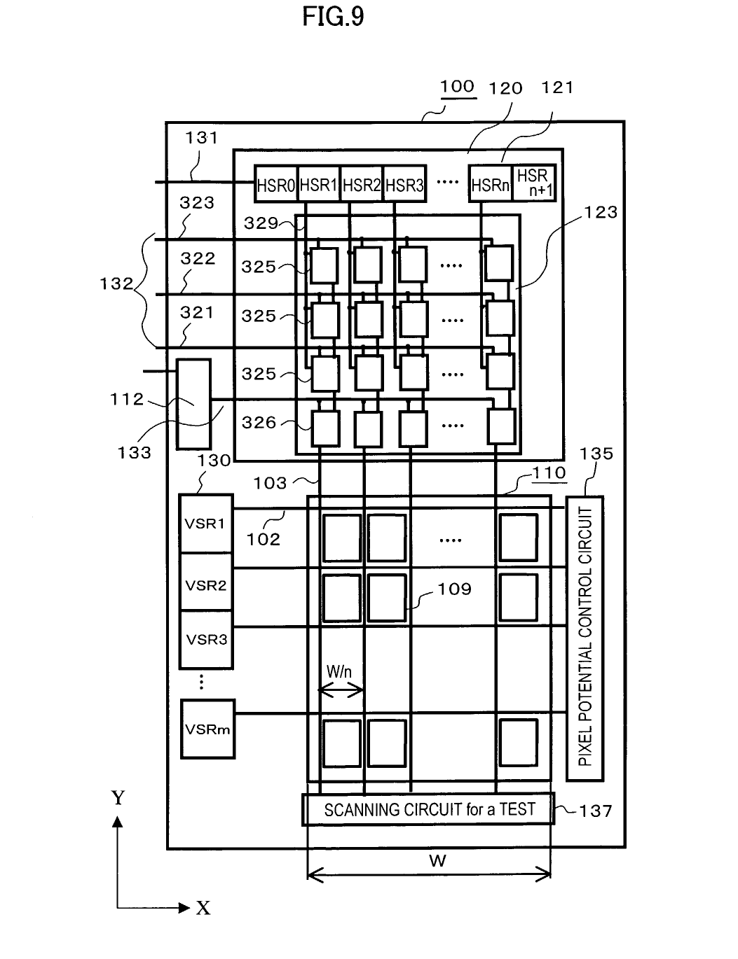

Subsequently, FIG. 9 shows a block diagram of the liquid crystal panel 100 when the video signals are inputted to the horizontal driving circuit 120 as digital signals and are subjected to the digital-analogue conversion in the voltage selecting circuit 123.

As mentioned previously, the gray scale voltage supplied to the pixel electrodes 109 is outputted from the voltage selecting circuit 123. When the number of gray scales to be displayed on the liquid crystal panel 100 is increased, the voltage selecting circuit 123 selects the voltage outputted to the video signal line 103 among a large number of gray scales. Further, a data quantity which is transmitted from the display control device 111 to the display data lines 132 connected to the voltage selecting circuit 123 is also increased. Accordingly, when the number of gray scales to be displayed on the liquid crystal panel 100 is increased, there arises a problem that the number of the display data lines 132 is increased and the circuit size of the voltage selecting circuit 123 becomes large accordingly. Here arises a necessity of constituting the voltage selecting circuit 123 as small as possible and a necessity of effectively arranging the voltage selecting circuit 123 in the inside of the liquid crystal panel. Further, particularly with respect to the driving circuit incorporating liquid crystal display device shown in FIG. 2 in which the driving circuits and the display part are mounted on the same substrate, a problem occured when the region where the driving circuits are formed is increased is also discussed.

In FIG. 9, the voltage selecting circuit 123 includes display data processing circuits 325 and gray scale voltage outputting circuit 326, wherein the display data processing circuits 325 and the gray scale voltage outputting circuits 326 are provided such that they are arranged on the extension lines of the video signal lines 103.

The display control circuit 111 (not shown in the drawing) is connected to the horizontal driving circuit 120 through three display data lines (321-323) which constitute the display data lines 132. These display data lines (321-323) are provided as signal lines for video signals per bit.

The display data are sequentially outputted to the display data lines (321-323) and timing signals for fetching the display data are outputted from the horizontal shift register 121. Timing signal lines 329 outputted from the horizontal shift register 121 are connected to the voltage selecting circuit 123 and the timing signals are transmitted to the voltage selecting circuit 123 through these timing signal lines 329. Symbols HSR1 to HSRn indicate two-way shift registers. The horizontal shift register 121 is constituted of the two-way shift registers HSR. The timing signals are outputted from the two-way shift registers HSR in accordance with signals (shift clocks) of the timing control signal lines 131. The timing signals indicate the timing at which the display data outputted to the display data signal lines (321 to 323) are fetched to the display data processing circuits 325 for every video signal line. Here, the two-way shift registers HSR0 and HSRn+1 are dummy two-way shift registers. Further, in FIG. 9, a voltage generating circuit 112 and the liquid crystal panel 100 are formed on the same substrate and a gray scale voltage line 133 outputted from the voltage generating circuit 112 is connected to the gray scale voltage outputting circuits 326.

A plurality of (n pieces) of video signal lines 103 are provided to the display part 110 at an approximately equal interval. The interval of these video signal lines 103 is substantially equal to a width of the pixel electrodes 109 provided to the display part 110. That is, within the display part 110 having a fixed area, the number of pixels which can be mounted is set by the Standard. Accordingly, the size of a region in which the pixel is formed is determined by the size of the display part 110 and the number of pixels. The interval of the video signal lines 103 is also selected in accordance with the size of the region in which the pixel is formed. For example, when the number of pixels in the lateral direction (X direction) in the drawing of the display part 110 is set to n pieces and the lateral width of the display part 110 is set to W, a pixel pitch becomes W/n and the interval of the video signal lines 103 assumes a value which is substantially equal to W/n of the pixel pitch. Further, the width of the display data processing circuits 325 and the gray scale voltage outputting circuits 326 which are provided on the extension line of the video signal lines 103 also assumes a value which is substantially equal to W/n of the pixel pitch.

On the extension line of one video signal line 103, to output the gray scale voltage to the video signal line 103, the display data processing circuit 325 and the gray scale voltage outputting circuit 326 are formed. For example, focusing on one arbitrary video signal line, the display data processing circuit 325 and the gray scale voltage outputting circuit 326 are also formed on the extension line of the neighboring video signal line 103. Accordingly, unless the width of the display data processing circuit 325 and the gray scale voltage outputting circuit 326 is held within the width of the pixel pitch, there arises a problem that the display data processing circuit 325 and the gray scale voltage outputting circuit 326 overlap the neighboring display data processing circuit 325 or the gray scale voltage outputting circuit 326. That is, when the display part is made small or when the number of pixels is increased, there arises a problem that to form the driving circuits within the pixel pitch, the width of the circuits must be taken into consideration.

Accordingly, to efficiently accommodate the display data processing circuits 325 and the gray-scale voltage outputting circuits 326 within the width of the pixel pitch, in this embodiment, the arrangement of the display data processing circuits 325 is divided every display data line in conformity with the arrangement of the display data lines and the display data processing circuits 325 are arranged on the extensions of the video signal lines 103.

As shown in FIG. 9, the display data lines (321-323) are outputted from the display control circuit 111 and are connected to the display data processing circuits 325. In this embodiment, a case in which 3 bits corresponding to display data of 8 gray scales are adopted is exemplified and hence, three display data lines (321-323) are provided. Here, although the case in which the number of display data lines is three is explained in this embodiment for the sake of brevity, the number of display data lines can be arbitrarily selected in accordance with the display data.

The display data processing circuits 325 are provided in a divided form for respective display data lines (321-323) and perform processing with respect to the value of every bit of the display data and transmit a result of processing to the gray scale voltage outputting circuits 326. The gray scale voltage outputting circuits 326 output the gray scale voltages in accordance with the display data based on the result of processing at the display data processing circuits 325.

As mentioned previously, the interval of the video signal lines 103 is restricted by the size of the pixel electrodes 109 provided to the display part 110. On the other hand, with respect to the interval between the neighboring display data lines, it is possible to take the sufficiently wide value such that the display data processing circuits 325 can be provided. As shown in FIG. 9, by dividing the display data processing circuit 325 for every constitution corresponding to respective display data line and arranging in a row in parallel on the extension line (Y direction in the drawing) of the video signal line 103, it is possible to accommodate the display data processing circuits 325 within the interval of the video signal line 103. However, there exists a limit in widening the interval between the display data lines and it is necessary to make the interval as small as possible.

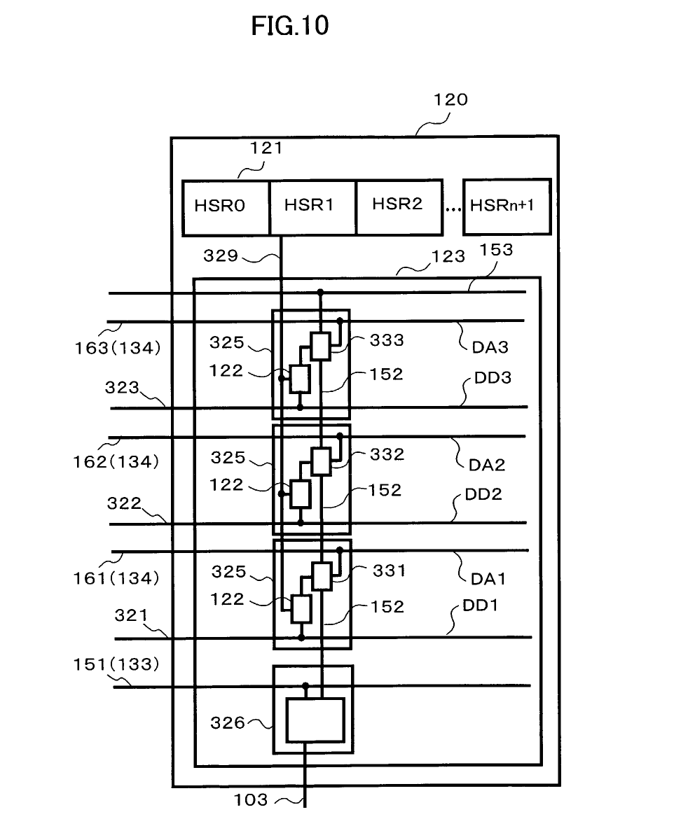

Subsequently, the voltage selecting circuit 123 which is provided in a divided form for every display data line is explained in detail in conjunction with FIG. 10. FIG. 10 is a schematic block diagram showing the circuit constitution of the voltage selecting circuit 123. In FIG. 10, to prevent the drawing from becoming complicated, the constitution of the voltage selecting circuit 123 is shown with respect to one video signal line 103.

As mentioned previously, the voltage selecting circuit 123 is provided with the display data processing circuit 325 for every display data line. A time control signal line 134 (161-163) is connected to each display data processing circuit 325. The time control lines 134 (161-163) are supplied from the display control device 111 not shown in the drawing. In the drawing, numeral 122 indicates display data holding circuits. The display data holding circuits 122 record the display data of the display data lines (321-323) in response to signals of the timing signal lines 329 outputted from the horizontal shift register 121.

Further, numerals 331, 332, 333 are processing transmitting circuits which perform processing between outputs of the display data holding circuits 122 and signals of the time control signal lines (161-163) and output results of processing to a processing result signal line 152. The processing transmitting circuits (331-333) are connected in series by the processing result signal line 152. Further, the gray scale voltage outputting circuit 326 is also connected in series with the processing transmitting circuits (331-333) using the processing result signal line 152. The gray scale voltage outputting circuit 326 selects the gray scale voltage on a voltage bus line 151 in accordance with the processing result transmitted from the processing transmitting circuits (331-333) and outputs the selected gray scale voltage to the video signal line 103. Here, the voltage bus line 151 indicates a signal line which changes the voltage value along with the lapse of time among signal lines indicated by the gray scale voltage line 133 in FIG. 9. Further, although the voltage bus line is indicated by a single line in FIG. 10, the voltage bus line may be constituted of a plurality of lines. In this embodiment, the processing transmitting circuits (331-333) and the gray scale voltage outputting circuit 326 are connected to each other with the processing result signal lines 152 which are smaller than the display data lines in number and hence, it is possible to omit the wiring in the longitudinal direction in the drawing. That is, the data transmitted through three display data lines (321-323) is computed by the processing transmitting circuits (331-333) and the result of processing is transmitted in the longitudinal direction using a single processing result signal line 152 so that the number of wiring is reduced. Further, by arranging the processing transmitting circuits (331-333) in parallel in the longitudinal direction, it is possible to narrow the width of constitution which outputs the gray scale voltage to the video signal line 103.

Subsequently, a method in which the gray scale voltage is selected and is outputted to the video signal line 103 by the gray scale voltage outputting circuit 326 is explained. The voltage bus line 151 is connected to the gray scale voltage outputting circuit 326. The voltage value of the voltage bus line 151 is changed as time lapses and the change of the voltage value is repeated at a fixed cycle or period. Accordingly, by electrically connecting the voltage bus line 151 and the video signal line 103 to each other by the gray scale voltage outputting circuit 326 when the voltage on the voltage bus line 151 which is changed along with the lapse of time assumes a desired voltage value, and by electrically interrupting the connection between the voltage bus line 151 and the video signal line 103 when the voltage on the voltage bus line 151 does not assume the desired voltage value, it is possible to output the desired voltage on the video signal line as the gray scale voltage.

The manner of operation of the voltage selecting circuit 123 is explained briefly. First of all, the display data is held in the display data holding circuit 122 in response to the timing signal which the horizontal shift register 121 outputs. Subsequently, the value of the display data holding circuit 122 is transmitted to the processing transmitting circuits (331-333). The value of the time control signal of the time control signal lines (161-163) is changed along with the lapse of time and the processing is performed between the value of the display data holding circuit 122 and the value of the time control signal of the time control signal lines (161-163) in the processing transmitting circuits (331-333). The processing result of the processing transmitting circuits (331-333) is transmitted to the gray scale voltage outputting circuit 326. When the voltage of the voltage bus line 151 agrees to the gray scale voltage indicated by the display data, the processing result of the processing transmitting circuits (331-333) is outputted and the gray scale voltage outputting circuit 326 outputs the gray scale voltage to the video signal line 103 from the voltage bus line 151.

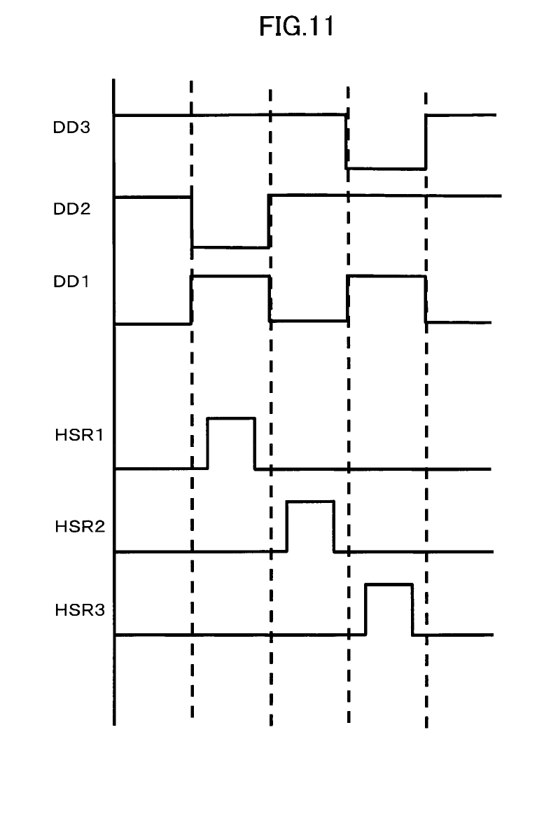

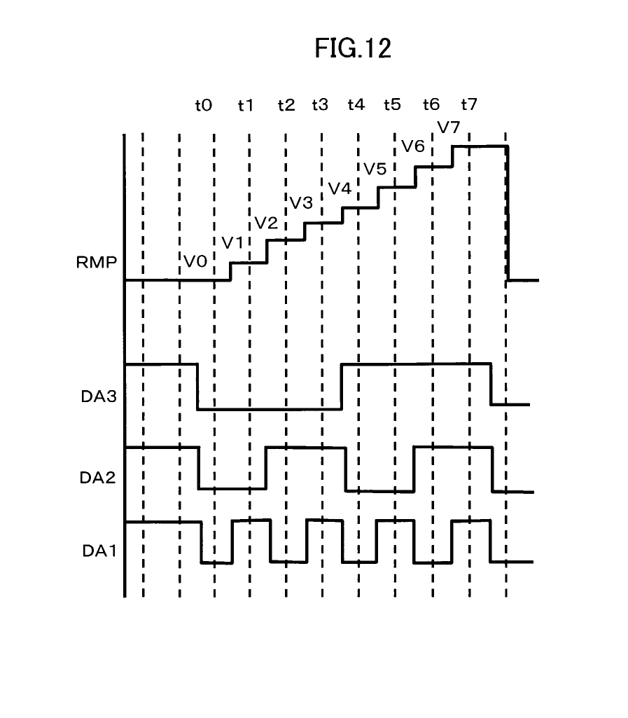

Subsequently, the manner of operation of the circuits shown in FIG. 9 and FIG. 10 is explained using timing charts of respective signals shown in FIGS. 11 and 12.

First of all, FIG. 11 shows the display data (DD1-DD3) outputted to the display data lines (321-323) and the timing signals HSR1-HSR3 outputted from the horizontal shift register 121. In FIG. 9, the display data (DD1-DD3) are outputted to the display data lines (321-323) and the timing signals (HSR1-HSR3) are sequentially outputted from the horizontal shift register 121. Here, although the timing signals are indicated by three signals HSR1 to HSR3 in FIG. 11, it is assumed that the necessary number of timing signals which match the number of video signal lines are outputted from the horizontal shift register 121.

The display data (DD1-DD3) express data of three bits in which DD1 constitutes the least significant bit. With respect to the values of respective bits during a period in which the timing signal HSR1 is outputted, the value of display data DD1 assumes a high level, the value of display data DD2 assumes a low level and the value of the display data DD3 assumes a high level. In this embodiment, the state in which the display data (DD1-DD3) assumes the high level is expressed as [1] and a state in which the display data (DD1-DD3) assumes the low level is expressed by [0]. Accordingly, the values of the display data during the period in which the timing signal HSR1 is outputted assume (1, 0, 1) in the order from the least significant bit.

In FIG. 11, when the timing signal HSR1 is outputted to the timing signal line 329 in the state in which the display data (DD1-DD3) assume (1, 0, 1), the display data (DD1-DD3) are fetched into the display data holding circuit 122.

Then, the manner of operation after the display data are fetched into the display data holding circuit 122 is explained in conjunction with FIG. 12. In FIG. 12, RMP indicates a gray scale voltage and the gray scale voltage RMP is supplied to the voltage bus line 151 in FIG. 10 from the voltage generating circuit 112 (not shown in the drawing). As shown in FIG. 12, the gray scale voltage RMP is a voltage which is changed along with the lapse of time in a step-like manner. In FIG. 12, it is assumed that the gray scale voltage V0 is written in the pixel electrodes when the state of the display data (DD1-DD3) is (1, 0, 1) and the gray scale voltage V7 is written in the pixel electrodes when the state of the display data (DD1-DD3) is (0, 0, 0).

In FIG. 12, a case in which (1, 0, 1) is fetched into the display data holding circuit 122 as the state of the display data (DD1-DD3) is explained. As mentioned previously, in FIG. 12, the RMP indicates the gray scale voltage and this gray scale voltage RMP is changed in a step-like manner along with the lapse of time. Further, the data values of time control pulses (DA1-DA3) are also changed in synchronism with the value of gray scale voltage RMP. In this embodiment, a case in which when the values of the display data holding circuit 122 become equal to the values of the time control pulses (DA1-DA3), the processing transmitting circuits (331-333) assume the ON state and a voltage which is supplied from a fixed voltage line 153 to the processing result signal line 152 is transmitted to a next-stage processing transmitting circuit is explained. Here, it is possible to adopt various modes including a mode in which the processing transmitting circuits (331-333) assume the ON state when the values of the time control pulse (DA1-DA3) are inverted with respect to the values of the display data holding circuit 122.

In FIG. 12, at the timing t0, all time control pulses (DA1-DA3) assume the low level and hence, all processing transmitting circuits (331-333) are turned off. Thereafter, when the values of the time control pulses (DA1-DA3) assume the same state (1, 0, 1) with the display data along with the lapse of time, all processing transmitting circuits (331-333) assume the ON state and hence, the voltage supplied from the fixed voltage line 153 is transmitted to the gray scale voltage outputting circuit 326 from the processing result signal line 152. When the voltage of the fixed voltage line 153 is transmitted to the gray scale voltage outputting circuit 326, the gray scale voltage outputting circuit 326 cuts off the electrical connection between the voltage bus line 151 and the video signal lines 103. Accordingly, the voltage V5 of the voltage bus line 151 at the time of cutting off is held in the video signal line 103.

Although a case in which the digital-analogue conversion method is adopted in the voltage selecting circuit 123 has been explained heretofore, there arises a problem that the size of the circuits is increased when the digital-analogue conversion method is adopted. Further, since the width in the X direction of the voltage selecting circuit 123 is restricted by the pixel pitch, the regions in which circuits are formed are elongated in the Y direction. Although the sealing material 12 is filled at four sides of the display part 110 in the outside of the peripheral frame 11 with a uniform width as mentioned previously, when there exists the side where the size of the circuit to be formed is increased among four sides, the difference arises in width among the regions where the sealing material 12 is filled. When the difference arises in width among the regions where the sealing material 12 is filled, this gives rise to a problem that the filling time of the sealing material 12 differs among sides or a problem that the sealing material 12 is not filled sufficiently in the side or a problem that the liquid crystal composition which is leaked into the filling region at the time of assembling the liquid crystal panel cannot be sufficiently removed.

To explain the peripheral frame 11 and the display part 110, the reflective type liquid crystal display device is first explained. As one of reflective type liquid crystal display elements, there has been known an electrically controlled birefringence mode. In the electrically controlled birefringence mode, a voltage is applied between reflection electrodes and counter electrodes so as to change the orientation of molecules of liquid crystal composition and, as a result, the refractive index anisotropy in a liquid crystal panel is changed. That is, the electrically controlled birefringence mode is a mode in which an image is formed by making use of the change of the refractive index anisotropy as the change of optical transmissivity.

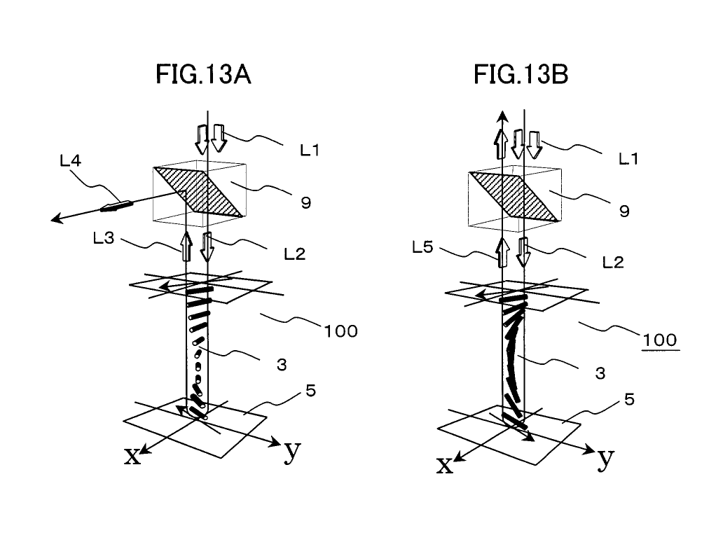

Further, a single polarizer twisted nematic mode (SPTN) which constitutes one of the electrically controlled birefringence mode is explained in conjunction with FIG. 13. Numeral 9 indicates s polarization beam splitter which splits an incident light L1 from a light source (not shown in the drawing) into two polarized lights and emits lights L2 formed of linear polarized beams. Although a case in which light (P polarized light) which passes through the polarization beam splitter 9 is used is exemplified in FIG. 13, it is possible to use light (S polarized light) which is reflected on the polarization beam splitter 9. As the liquid crystal composition 3, nematic liquid crystal having positive dielectric anisotropy in which the long axis of liquid crystal molecules is arranged parallel to a driving circuit substrate 1 and a transparent substrate 2 is used. Further, the liquid crystal molecules are oriented in the state that the liquid crystal molecules are twisted by approximately 90 degrees due to an orientation film.

First, a case in which a voltage is not applied to the liquid crystal is shown in FIG. 13A. Light which is incident on the liquid crystal panel 100 becomes the elliptically polarized light due to the birefringence of liquid crystal composition 3 and becomes a circularly polarized, light on a surface of a reflection electrode 5. Light reflected on the reflection electrode 5 again passes through the liquid crystal composition 3 and becomes the elliptically polarized light and returns to a linear polarized light at the time of emitting and light L3 (S polarized light) which has a phase rotated by 90 degrees with respect to the incident light L2 is emitted. Although the emitted light L3 is incident on the polarization beam splitter 9 again, the incident light L3 is reflected on the polarizing surface and becomes an emitting light L4. The display is performed by irradiating this emitting light L4 onto the screen or the like. In this case, a display method which is referred to as a so-called normally white (normally open) which emits light when a voltage is not applied to the liquid crystal composition 3 is adopted.

On the other hand, FIG. 13B shows a case in which the voltage is applied to the liquid crystal composition 3. When the voltage is applied to the liquid crystal composition 3, the liquid crystal molecules are oriented in the direction of an electric field and hence, a rate that the birefringence is generated in the inside of the liquid crystal is reduced. Accordingly, the light L2 which is incident on the liquid crystal panel 100 in the form of linearly polarized light is directly reflected on the reflection electrode 5 and light having the same polarization direction as the incident light L2 is emitted as light L5. The emitted light L5 passes through the polarization beam splitter 9 and returns to the light source. Accordingly, light is not irradiated to a screen or the like and hence, a black display is performed.

In the single polarizer twisted nematic mode, the orientation direction of the liquid crystal molecules is parallel to the substrate and hence, the general orientation method can be used whereby the favorable process stability is obtained. Further, when the single polarizer twisted nematic mode is used in the normally white mode, it is possible to ensure the tolerance with respect to the display defect which occurs at the low voltage side. That is, in the normally white method, the dark level (black display) is obtained by applying a high voltage to the liquid crystal composition. When the high voltage is applied to the liquid crystal composition, most of the liquid crystal molecules are arranged in the electric field direction perpendicular to the surface of the substrate and hence, the display of dark level does not largely depend on the initial orientation state at the time of applying the low voltage to the liquid crystal composition. Further, human naked eyes recognize the irregularities of luminance as the relative ratio of luminance and show a reaction similar to a logarithmic scale with respect to the luminance. Accordingly, the human naked eyes are sensitive to the change or the fluctuation of the dark level. Due to these reasons, the normally white method is an advantageous method with respect to the irregularities of luminance derived from the initial orientation state.

However, in the above-mentioned electrically controlled birefringence mode, the cell gap is required to have the high accuracy. That is, the above-mentioned electrically controlled birefringence mode makes use of the phase difference between the abnormal light and the normal light which are generated during light passes through the inside of the liquid crystal layer and hence, the intensity of transmitting light depends on the retardation Δn×d between the abnormal light and the normal light. Here Δn indicates the refractive index anisotropy and d indicates a cell gap between the transparent substrate 2 and the driving circuit substrate 1 formed by spacers which will be explained later.

Accordingly, in this embodiment, by taking the display irregularities into consideration, the cell gap accuracy is set to a value equal to or less than ±0.05 μm. Further, in the reflective type liquid crystal display element, light which is incident on the liquid crystal is reflected on the reflection electrode and passes through the liquid crystal layer again. Accordingly, provided that the liquid crystal having the same refractive index anisotropy Δn is used, the cell gap d of the reflective type liquid crystal display element is halved compared to the cell gap of the transmissive type liquid crystal display element. While the cell gap d is approximately 5-6 μm in a general transmissive type liquid crystal display element, the cell gap is approximately 2 μm in this embodiment.

In this embodiment, to cope with a demand for the high cell gap accuracy and the smaller cell gap, a method which forms columnar spacers on the driving circuit substrate 1 is employed in place of a bead scattering method which has been known conventionally.

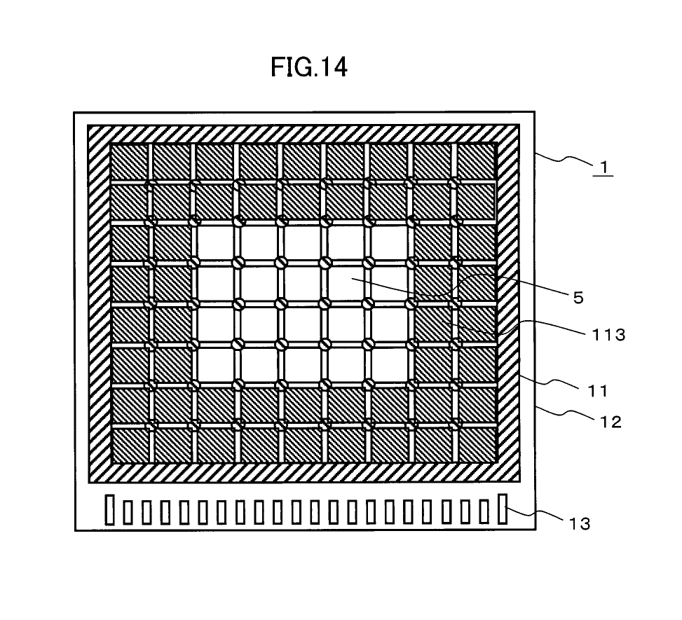

FIG. 14 is a schematic plan view showing the arrangement of the reflection electrodes 5 and the spacers 4 formed on the driving circuit substrate 1. A large number of spacers 4 are formed over an entire surface of the driving circuit substrate 1 in a matrix array to ensure the fixed gap. The reflection electrode 5 constitutes a minimum pixel of an image which the liquid crystal display element forms. In FIG. 14, for the sake of brevity, four pixels and five pixels are shown in the longitudinal direction and in the lateral direction respectively using numeral 5.

In FIG. 14, the pixels arranged in a matrix consisting of four pixels in the longitudinal direction and five pixels in the lateral direction form an effective display region. An image displayed by the liquid crystal display element is formed in this effective display region. Outside the effective display region, dummy pixels 113 are provided. In the periphery of the dummy pixels 113, the peripheral frame 11 made of the same material as the spacers 4 is provided. Further, outside the peripheral frame 11, the sealing material 12 is applied. Numeral 13 indicates external connection terminals which are served for supplying signals from the outside to the liquid crystal panel 100.

As a material of the spacers 4 and the peripheral frame 11, a resin material is used. As the resin material, for example, a chemically amplifying type negative-type resist “BRP-113” (product name) produced by JSR Ltd. can be used. The resist material is applied onto the driving circuit substrate 1 on which the reflection electrodes 5 are formed using a spin coating method or the like and, thereafter, the resist is exposed following a pattern of the spacers 4 and the peripheral frame 11 using a mask. Then, the resist is developed using a removing agent thus forming the spacers 4 and the peripheral frame 11.

By forming the spacers 4 and the peripheral frame 11 using the resist material or the like as the raw material, it is possible to control the height of the spacers 4 and the peripheral frame 11 based on a film thickness of the coating material whereby the spacers 4 and the peripheral frame 11 can be formed with high accuracy. Further, the position of the spacers 4 can be determined using the mask pattern so that it is possible to accurately form the spacers 4 at desired positions. With respect to a liquid crystal projector, when the spacers 4 are present on the pixels, there arises a problem that shadows produced by spacers are observed in an enlarged projected image. By forming the spacers 4 by exposure and development using the mask pattern, it is possible to arrange the spacers 4 at positions which cause no problems when the image is displayed.

Further, the peripheral frame 11 is formed simultaneously with the spacers 4. Accordingly, as a method for filling the liquid crystal composition 3 between the driving circuit substrate 1 and the transparent substrate 2, it is possible to adopt a method in which the liquid crystal composition 3 is dropped on the driving circuit substrate 1, and thereafter, the transparent substrate 2 is laminated to the driving circuit substrate 1. There exists a drawback that the liquid crystal composition 3 is leaked to the outside of the peripheral frame 11 and remains in the region where the sealing material 12 is to be filled at the time of assembling the liquid crystal panel. Accordingly, it is necessary to perform an operation to remove the liquid crystal composition 3 remaining in the region to be filled with the sealing material 12.

After arranging the liquid crystal composition 3 between the driving circuit substrate 1 and the transparent substrate 2 and assembling the liquid crystal panel 100, the liquid crystal composition 3 is held within the region surrounded by the peripheral frame 11. Further, the outside of the peripheral frame 11 is coated with the sealing material 12 so that the liquid crystal composition 3 is sealed in the inside of the liquid crystal panel 100. As mentioned previously, the peripheral frame 11 is formed using the mask pattern and hence, the peripheral frame 11 can be formed on the driving circuit substrate 1 with high positional accuracy. Accordingly, it is possible to determine the boundary between the peripheral frame 11 and the liquid crystal composition 3 with high accuracy. Further, it is also possible to determine the boundary between the peripheral frame 11 and the region where the sealing material 12 is formed with high accuracy.

The sealing material 12 has a role of fixing the driving circuit substrate 1 and the transparent substrate 2 to each other and a role of preventing the entrance of material harmful to the liquid crystal composition 3 into the liquid crystal composition 3. When the sealing material 12 having fluidity is applied, the peripheral frame 11 constitutes a stopper for the sealing material 12. By providing the peripheral frame 11 as the stopper for the sealing material 12, it is possible to increase the tolerance in designing the boundary between the peripheral frame 11 and the liquid crystal composition 3 and the boundary between the peripheral frame 11 and the sealing material 12 whereby the distance between an end side of the liquid crystal panel 100 and the effective display region can be narrowed (narrow picture frame).

Since the peripheral frame 11 is formed such that the peripheral frame 11 surrounds the effective display region, at the time of applying the rubbing treatment to the driving circuit substrate 1, there arises a problem that the vicinity of the peripheral frame 11 can not be favorably subjected to rubbing due to the peripheral frame 11. The rubbing treatment is a treatment which orients the liquid crystal composition 3 in a fixed direction. In this embodiment, after forming the spacers 4 and the peripheral frame 11 on the driving circuit substrate 1, the orientation film 7 is applied. Thereafter, the rubbing treatment is performed by rubbing the orientation film 7 using a cloth or the like such that the liquid crystal composition 3 is oriented in the fixed direction.

In the rubbing treatment, since the peripheral frame 11 is projected from the driving circuit substrate 1, the orientation film 7 in the vicinity of the peripheral frame 11 is not sufficiently rubbed due to stepped portions formed by the peripheral frame 11. Accordingly, in the vicinity of the peripheral frame 11, the liquid crystal composition 3 is liable to form a portion where the orientation is not uniform. To prevent the display irregularities caused by the orientation defect of the liquid crystal composition 3 from becoming apparent, several pixels arranged inside the peripheral frame 11 are used as dummy pixels 113 constituting pixels which do not contribute to the display.

Here, when the dummy pixels 113 are formed and signals are supplied to the dummy pixels 113 in the same manner as the pixels 5, since the liquid crystal composition 3 is present between the dummy pixels 113 and the transparent substrate 2, there arises a problem that the display formed by the dummy pixels 113 is also observed. When the liquid crystal panel is used in the normally white, unless the voltage is applied to the liquid crystal composition 3, the dummy pixels 113 are displayed in white. Accordingly, the boundary of the display region becomes indefinite so that the display quality is damaged. Although the applying of light shielding to the dummy pixels 113 may be considered, since the distance between the pixels is several μm, it is difficult to form a light shielding frame accurately at the boundary of the display region. Accordingly, a voltage which makes the dummy pixels 113 perform the black display is supplied to the dummy pixels 113 so that the dummy pixels 113 are observed as a black frame which surrounds the display region.

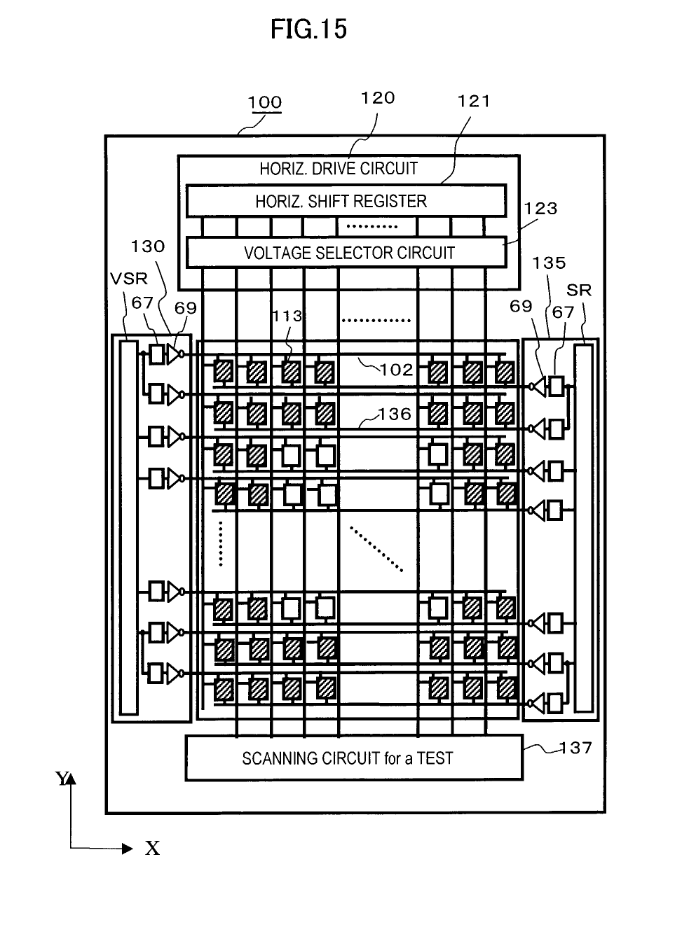

A method for driving the dummy pixels 113 is explained in conjunction with FIG. 15. To supply the voltage to the dummy pixels 113 such that the dummy pixels 113 assume the black display, the region where the dummy pixels are formed has a whole surface thereof subjected to the black display. When the region where the dummy pixels are formed has the whole surface thereof subjected to the black display, it is unnecessary to individually form the dummy pixels 113 in the same manner as the pixels in the display region. That is, the dummy pixels can be formed such that a plurality of dummy pixels are electrically connected to each other. Further, to take time necessary for driving the liquid crystal panel into consideration, it is useless to provide time for writing exclusively for the dummy pixels. Accordingly, it is possible to provide one dummy pixel electrode by continuously forming electrodes of a plurality of dummy pixels. However, when one dummy pixel is formed by continuously connecting a plurality of dummy pixels, an area of the pixel electrode is increased and hence, the liquid crystal capacitance is increased. As mentioned previously, when the liquid crystal capacitance is increased, the efficiency to reduce the pixel voltage using the pixel capacitance is lowered.

Accordingly, the dummy pixels 113 are also formed individually in the same manner as the pixels in the effective display region. However, when the writing is performed every one line in the same manner as the effective pixels, the time for driving the liquid crystal panel is prolonged by time necessary for driving a plurality of newly-provided dummy lines. Alternately, there arises a problem that time necessary for writing signals in the effective pixels is shortened by the time necessary for driving a plurality of newly-provided dummy lines. On the other hand, when it is necessary to perform the high-definition display, the high-speed video signals (signal having high dot clocks) are inputted and hence, the restriction on writing the signals into the pixels is further increased. Accordingly, to save time for writing several lines during the writing time for one screen, as shown in FIG. 15, with respect to the dummy pixels 113, timing signals for a plurality of lines are outputted from a vertical two-way shift register VSR of the vertical driving circuit 130 and these timing signals are inputted to a plurality of level shifters 67 and a plurality of outputting circuits 69 so as to output scanning signals. Further, also with respect to the pixel electrode control circuit 135, timing signals for a plurality of lines are outputted from a two-way shift register SR and the timing signals are inputted to a plurality of level shifters 67 and a plurality of outputting circuits 69 so as to output the pixel electrode control signals.

Here, although the case in which signals are written in a plurality of lines of dummy pixels 113 simultaneously has been explained, the signals may be written in the dummy pixels 113 every one line. Further,the display part 110 indicates a region which includes the effective display region and the dummy pixels 113.

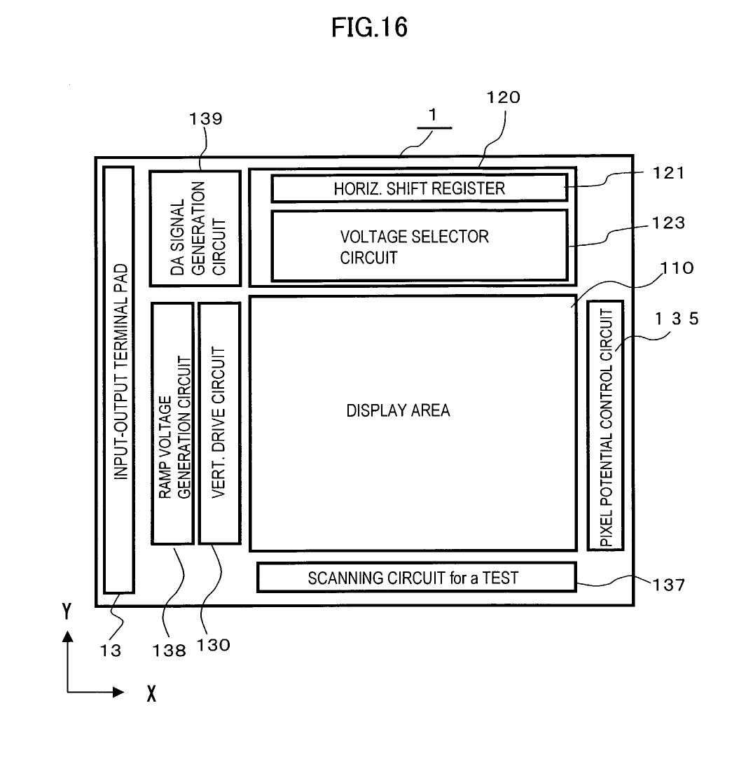

Subsequently, a state in which a circuit area of the horizontal driving circuit 120 is increased is explained in conjunction with FIG. 16. Since the horizontal driving circuit 120 is a circuit which allows the inputting of display data thereinto and outputs the gray scale voltages, when the number of gray scales and the number of pixels of the liquid crystal panel 100 are increased, the size of the circuit is also increased. Particularly, when the horizontal driving circuit 120 adopts the digital-analogue conversion method, as mentioned previously, it is necessary to accommodate the width of the circuit for every video signal line within the pixel pitch and hence, the width of the circuit in the Y direction in the drawing is increased. Further, when the number of gray scales is increased in the digital-analogue conversion method, the number of data signal lines and the number of conversion circuits (display data processing circuits 325 shown in FIG. 9) provided for respective data signal lines are also increased so that the width of the circuit is increased.

Further, when the above-mentioned digital analogue conversion circuit is used, it is necessary to provide a region where a ramp voltage generating circuit 138 for generating a ramp voltage and a DA signal generating circuit 139 for generating time control pulses or the like are formed and hence, a region which is arranged adjacent to the vertical driving circuit 130 also increases the width thereof in the X direction in the drawing. Further, when the inputting/outputting terminal pad part 13 is provided in the lateral direction (X direction) in the drawing with respect to the display part 110, the circuit region arranged at the lateral side of the vertical driving circuit 130 increases the width thereof in the X direction in the drawing.

When the area of the circuit forming region is increased as shown in FIG. 16, the width of region in which the sealing material 12 is filled becomes non-uniform.

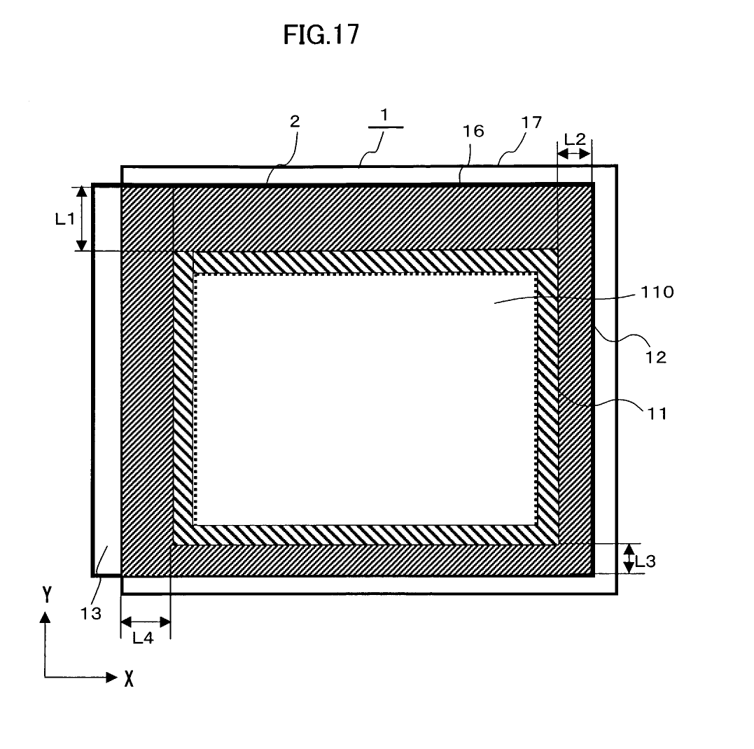

FIG. 17 shows a state in which the transparent substrate 2 is overlapped to the substrate 1 shown in FIG. 16 while sandwiching the peripheral frame 11 therebetween and the sealing material 12 is filled. In FIG. 17, the peripheral frame 11 is formed in the periphery of the display part 110 and the sealing material 12 is filled outside the peripheral frame 11.

As shown in FIG. 16, the width of the region where the horizontal driving circuit 120 is formed is increased and hence, the width L1 of the region where the sealing material 12 is filled is made wider than the width L3 of other region where the sealing material 12 is filled. Further, since it is necessary to provide the region where the ramp voltage generating circuit 138 and the DA signal generating circuit 139 are formed, the width L4 of the region where the sealing material 12 is filled is made wider than the width L2 of other region where the sealing material 12 is filled. Since the sealing material 12 is filled in a minute gap between the substrate 1 and the transparent substrate 2 (the gap of approximately 2 μm when the gap d is 2 μm) by making use of the capillary phenomenon, when the filling width is not uniform, regions where the filling is completed in a short period and regions where the filling is completed in a long period are generated thus giving rise to regions where the sealing material 12 is not sufficiently filled.

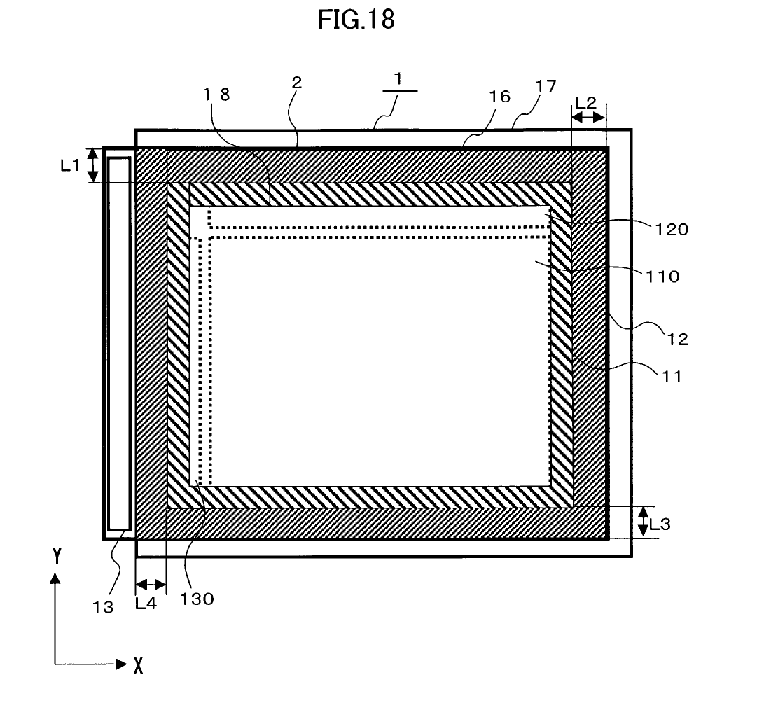

Subsequently, a case in which the region where the peripheral frame 11 is formed is expanded to the outside so as to make the filling width uniform is shown in FIG. 18.

In FIG. 18, an inner wall 18 of the peripheral frame 11 is provided outside the display part 110 and the inner wall 18 is formed on the region where the horizontal driving circuit 120 and the vertical driving circuit 130 are formed. In the constitution shown in FIG. 18, the widths L1, L2, L3, L4 of the region where the sealing material 12 is filled are set to approximately equal length. Accordingly, the sealing material 12 can be favorably filled. However, there arises a problem attributed to the constitution that the liquid crystal composition is provided over the region where the driving circuits are formed.

The liquid crystal composition has a property that the liquid crystal composition is deteriorated in a state that a fixed voltage is applied to the liquid crystal composition. Accordingly, when the liquid crystal composition is formed over the driving circuits, the liquid crystal composition is deteriorated due to an electric field generated by the driving circuits. To cope with such a problem, a conductive layer is formed on the driving circuits and the conductive layer has the same potential as the counter electrodes such that the voltage is not applied to the liquid crystal composition. Further, the region arranged outside the display part 110 and extending to the inner wall 18 of the peripheral frame is covered with a light shielding frame such that the observation from the outside is prevented. Particularly, in the driving method which adopts the normally white, the white display is performed in the state that the electric field is not applied to the liquid crystal composition and hence, it is necessary to conceal the region with the light shielding frame. The manner of assembling the liquid crystal display device including the light shielding frame is explained in detail later.

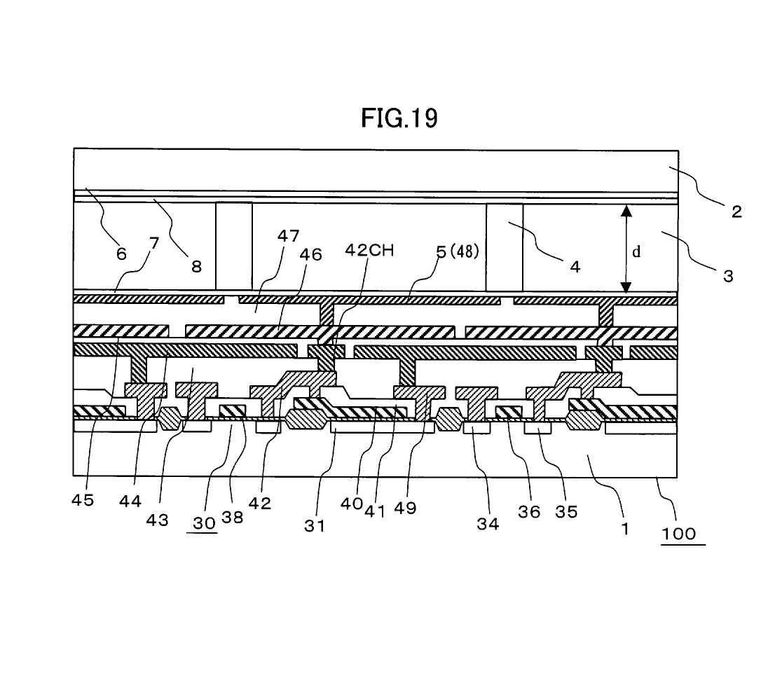

Subsequently, the pixel part of the reflective type liquid crystal display device LCOS according to the present invention is explained in conjunction with FIG. 19. FIG. 19 is a schematic cross-sectional view of the reflective type liquid crystal display device according to one embodiment of the present invention. In FIG. 19, numeral 100 indicates a liquid crystal panel, numeral 1 indicates a driving circuit substrate which constitutes a first substrate, numeral 2 indicates a transparent substrate which constitutes a second substrate, numeral 3 indicates the liquid crystal composition and numeral 4 indicates spacers. The spacers 4 form a cell gap d which constitutes a fixed distance between the driving circuit substrate 1 and the transparent substrate 2. The liquid crystal composition 3 is inserted into this cell gap d. Numeral 5 indicates reflection electrodes (pixel electrodes) which are formed on the driving circuit substrate 1. Numeral 6 indicates counter electrodes. A voltage is applied to the liquid crystal composition 3 between the counter electrodes 6 and the reflection electrodes 5. Numerals 7, 8 are orientation films which are served for orienting liquid crystal molecules in a fixed direction. Numeral 30 indicates active elements which supply gray scale voltages to the reflection electrodes 5.

Numerals 34, 35, 36 respectively indicate a source region, a drain region and a gate electrode of each active element 30. Numeral 38 indicates an insulation film, numeral 31 indicates first electrodes which form pixel capacitances and numeral 40 indicates second electrodes which form pixel capacitances. The first electrodes 31 and the second electrodes 40 form capacitances by way of the insulation film 38. In FIG. 19, the first electrode 31 and the second electrode 40 are indicated as typical electrodes which form the pixel capacitance. However, provided that a conductive layer which is electrically connected with the pixel electrode and a conductive layer which is electrically connected with a pixel potential control signal line face each other in an opposed manner while sandwiching a dielectric layer therebetween, it is possible to form pixel capacitance.

Numeral 41 indicates a first interlayer film and numeral 42 indicates a first conductive film. The first conductive film 42 is served for electrically connecting the drain region 35 with the second electrode 40. Numeral 43 indicates a second interlayer film, numeral 44 indicates a first light shielding film, numeral 45 indicates a third interlayer film and numeral 46 indicates a second light shielding film. A through hole 42CH is formed in the second interlayer film 43 and the third interlayer film 45 so as to electrically connect the first conductive film 42 and the second light shielding film 46. Numeral 47 indicates a fourth interlayer film and numeral 48 indicates a second conductive film which forms the reflection electrode 5. The gray scale voltages are transmitted to the reflection electrode 5 from the drain region 35 of the active element 30 through the first conductive film 42, the through hole 42CH and the second light shielding film 46.

The liquid crystal display device according to this embodiment is of a reflective type, wherein a large quantity of light is irradiated to the liquid crystal panel 100. The light shielding film performs the light shielding such that the light is not incident on semiconductor layers of the driving circuit substrate. In the reflective type liquid crystal display device, the light which is irradiated to the liquid crystal panel 100 is incident from the transparent substrate 2 side (upper side in FIG. 19), passes through the liquid crystal composition 3, is reflected on the reflection electrode 5, again passes through the liquid crystal composition 3 and the transparent substrate 2, and is emitted from the liquid crystal panel 100. However, a portion of the light irradiated to the liquid crystal panel 100 leaks into the driving circuit substrate side through a gap formed between the reflection electrodes 5. The first light shielding film 44 and the second light shielding film 46 are provided for preventing the light from being incident on the active elements 30. In this embodiment, these light shielding films are formed of a conductive layer, wherein the second light shielding film 46 is electrically connected to the reflection electrodes 5 and the pixel potential control signals are supplied to the first light shielding film 44 whereby the light shielding films also function as a portion of the pixel capacitance.

Here, by supplying the pixel potential control signal to the first light shielding layer 44, it is possible to provide the first light shielding film 44 as an electric shielding layer between the second light shielding film 46 to which the gray scale voltages are supplied and the first conductive layer 42 which forms video signal lines 103 or a conductive layer (a conductive layer formed on the same layer as the gate electrode 36) which constitutes the scanning signal lines 102. Accordingly, parasitic capacitance components generated between the first conductive layer 42, the gate electrodes 36 or the like and the second light shielding film 46 or the reflection electrode 55 can be reduced. As mentioned previously, it is necessary to make the pixel capacitance CC have the sufficiently large value with respect to the liquid crystal capacitance CL. By providing the first light shielding film 44 as the electric shielding layer, the parasitic capacitance which is connected in parallel with the liquid crystal capacitance LC is also reduced so that it is possible to efficiently ensure the large pixel capacitance CC. Further, a jump phenomenon of noises from the signal lines can be also reduced.

Further, when the reflective type liquid crystal display element is adopted and the reflection electrodes 5 are formed on a surface of the driving circuit substrate 1 at the liquid crystal composition 3 side, it is possible to use an opaque silicon substrate or the like as the driving circuit substrate 1. Further, it is possible to provide the active elements 30 and the wiring below the reflection electrodes 5 and hence, the reflection electrodes 5 which constitutes the pixels can be broadened and hence, it is possible to have an advantageous effect that a so-called high numerical aperture can be realized. Further, it is also possible to obtain an advantageous effect that heat generated by the light irradiated on the liquid crystal panel 100 can be dissipated from a rear surface of the driving circuit substrate 1.

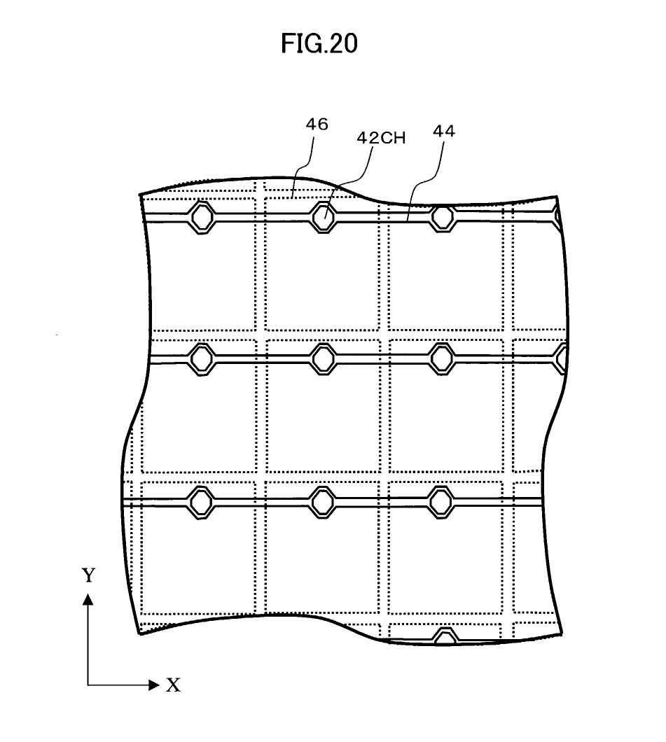

Subsequently, the utilization of the light shielding film as a portion of the pixel capacitance is explained. The first light shielding film 44 and the second light shielding film 46 face each other by way of the third interlayer film 45 thus forming a portion of the pixel capacitance. Numeral 49 indicates a conductive layer which forms a portion of the pixel potential control line 136. The first electrode 31 and the first light shielding film 44 are electrically connected to each other through the conductive layer 49. Further, it is possible to form the wiring from the pixel potential control circuit 135 to the pixel capacitance using the conductive layer 49. However, the first light shielding film 44 is used as the wiring in this embodiment. FIG. 20 shows the constitution in which the first light shielding film 44 is used as the pixel potential control line 136.

FIG. 20 is a plan view showing the arrangement of the first light shielding films 44. Although the numeral 46 indicates the second light shielding films, the position of the second light shielding films 46 is indicated by a dotted line. Numeral 42CH indicates through holes which are served for connecting the first conductive film 42 and the second light shielding films 46. For facilitating the understanding of the first light shielding films 44, other constitutions are omitted in FIG. 20. The first light shielding films 44 have the function of the pixel potential control lines 136 and are continuously formed in the X direction in the drawing. The first light shielding films 44 function as light shielding films and hence, the light shielding films 44 cover an entire surface of the display region. However, to make the first light shielding films 44 also have the function of the pixel potential control lines 136, the first light shielding films 44 are extended in the X direction (direction parallel to the scanning signal lines 102) and are formed in a line shape in parallel in the y direction and are connected to the pixel potential control circuit 135. Further, since the first light shielding films 44 also function as electrodes of the pixel capacitances, the first light shielding films 44 are formed such that they overlap the second light shielding films 46 with an overlapping area as large as possible. Further, to reduce light leaked from the light shielding films, the distance between neighboring first light shielding films 44 is formed as narrow as possible.

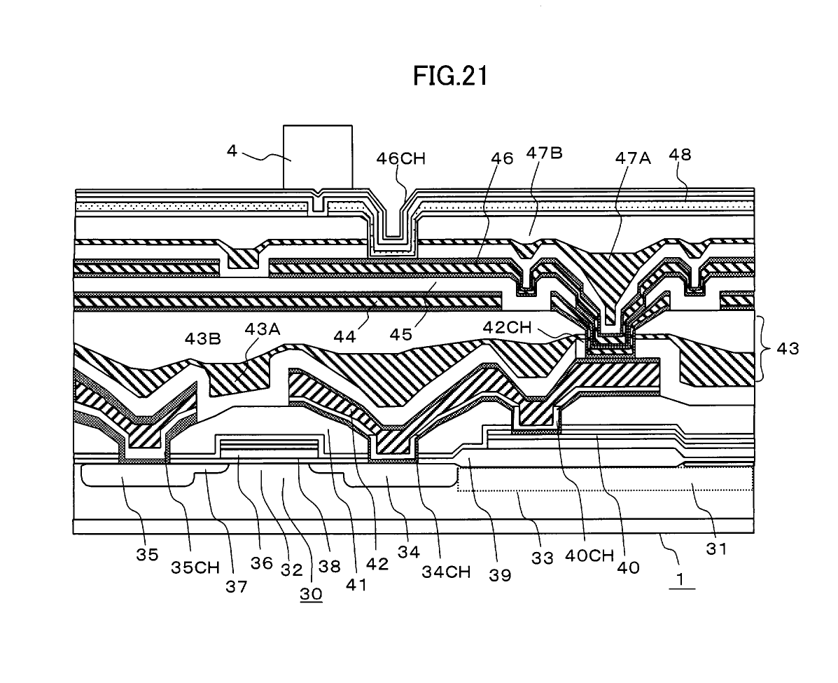

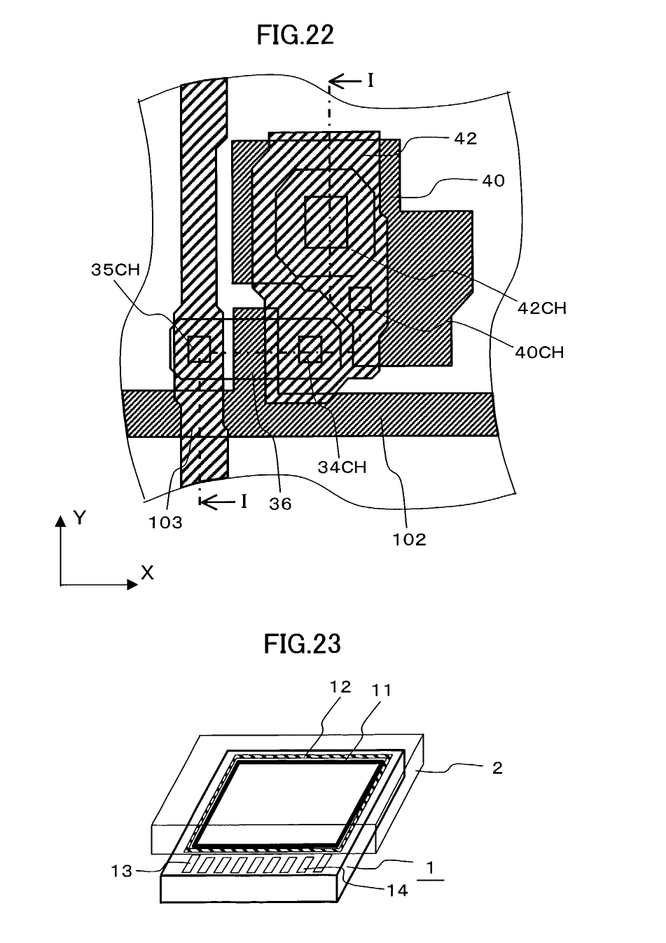

Then, the constitution of the active element 30 mounted on the driving circuit substrate 1 and the vicinity of the active element 30 is explained in detail in conjunction with FIG. 21 and FIG. 22. In FIG. 21 and FIG. 22, numerals equal to those shown in FIG. 19 indicate the identical constitutions. FIG. 22 is a schematic plan view showing the periphery of the active element 30. FIG. 21 is a cross-sectional view taken along a line I-I in FIG. 22. However, these drawings do not agree with each other with respect to the distances among respective components. Further, FIG. 22 shows the positional relationship between the scanning signal line 102 and the gate electrode 36, the positional relationship between the video signal line 103 and the source region 35, the drain region 34, and the positional relationship among the second electrode 40 which forms the pixel capacitance, the first conductive layer 42 and contact holes 35CH, 34CH, 40CH, 42CH. Other constitutions are omitted in FIG. 22.

In FIG. 21, numeral 1 indicates a silicon substrate which constitutes a driving circuit substrate, numeral 32 indicates a semiconductor region (p-type well) which is formed on the silicon substrate 1 by ion implantation, numeral 33 indicates a channel stopper, numeral 34 indicates a drain region which is made conductive and formed on the p-type well 32 by ion implantation, numeral 35 indicates a source region which is formed on the p-type well 32 by ion implantation, and numeral 31 indicates a first electrode of the pixel capacitance which is made conductive and formed on the p-type well 32 by ion implantation. Here, in this embodiment, although the p-type transistor is used as the active element 30, the active element 30 may be constituted of an n-type transistor.

Numeral 36 indicates agate electrode, numeral 37 indicates an offset region which attenuates the intensity of an electric field at an end portion of the gate electrode, numeral 38 indicates an insulation film, numeral 39 indicates a field oxide film which electrically separates transistors, numeral 40 indicates a second electrode which forms the pixel capacitance. The second electrode 40 forms the capacitance between the second electrode 40 and a first electrode 21 formed on the silicon substrate 1 by way of the insulation film 38. The gate electrode 36 and the second electrode 40 are formed of a two-layered film which is constituted by laminating a conductive layer for lowering a threshold value of the active element 30 and a conductive layer of low resistance onto the insulation film 38. As such a two-layered film, a film made of a polysilicon layer and a tungsten-silicide layer can be used. Numeral 41 indicates a first interlayer film and numeral 42 indicates a first conductive film. The first conductive film 42 is formed of a multi-layered film consisting of a conductive film made of barrier metal and a conductive film of low resistance which prevents the contact defect. As such a first conductive film, for example, a multi-layered metal film which is constituted of a titanium-tungsten film and an aluminum layer and is formed by sputtering can be used.

In FIG. 22, numeral 102 indicates the scanning signal line. In FIG. 22, the scanning signal lines 102 are extended in the X direction and are arranged in parallel in the Y direction, wherein the scanning signals which turn on or off the active elements 30 are supplied through the scanning signal lines 102. The scanning signal lines 102 are formed of a two-layered film which is also used for forming the gate electrodes. For example, the two-layered film which is formed by laminating a polysilicon layer and a tungsten silicide film layer can be used. The video signal lines 103 are extended in the Y direction and are arranged in parallel in the X direction, wherein the video signals which are written in the reflection electrode 5 are supplied through the reflection electrode 5. The video signal lines 103 are formed of a multi-layered metal film which is used for forming the first conductive film 42. For example, the multi-layered metal film which is constituted of a titanium tungsten film and an aluminum film can be used.

The video signals pass through the contact hole 35CH formed in the insulation film 38 and the first interlayer film 41 and are transmitted to the drain region 35 through the first conductive film 42. When the scanning signals are supplied to the scanning signal line 102, the active element 30 is turned on, the video signals are transmitted from the semiconductor region (p-type well) 32 to the source region 34, and are transmitted to the first conductive film 42 after passing through the contact hole 34CH. The video signals which are transmitted to the first conductive film 42 are transmitted to the second electrode 40 of the pixel capacitance through the contact hole 40CH.

Further, as shown in FIG. 21, the video signals pass through the contact hole 42CH and are transmitted to the reflection electrode 5. The contact hole 42CH is formed on the field oxide film 39. Since a film thickness of the field oxide film 39 is large, an upper portion of the field oxide film 39 is disposed at a high position compared to other constitution. By forming the contact hole 42CH above the field oxide film 39, it is possible to arrange the contact hole 42CH at a position close to the conductive film which constitutes an upper layer so that a length of a connection portion of the contact hole can be made short.

Further, as shown in FIG. 21, the second interlayer film 43 insulates the first conductive film 42 and the second conductive film 44. The second interlayer film 43 is formed of two layers consisting of a leveling film 43A which embeds irregularities formed due to respective constitutional components and an insulation film 43B which covers the leveling film 43A. The leveling film 43A is formed by applying SOG (spin on glass). The insulation film 43B is a TEOS film, wherein a SiO₂ film is formed by a CVD method using TEOS (Tetraethylorthsilicate) as a reaction gas.

After forming the second interlayer film 43, the second interlayer film 43 is polished by a CMP (chemical-mechanical polishing) method. That is, the second interlayer film 43 is leveled by polishing using the CMP method. The first light shielding film 44 is formed on the second leveled interlayer film 43. The first light shielding film 44 is formed of the same multi-layered metal film as that of the first conductive film 42 which is constituted of a tungsten film and an aluminum film.

The first light shielding film 44 covers an approximately entire surface of the driving circuit substrate 1 and openings are formed only at the contact holes 42CH. The third interlayer film 45 constituted of a TEOS film is formed on the first light shielding film 44. Further, the second light shielding film 46 is formed on the third interlayer film 45. The second light shielding film 46 is formed of the same multi-layered metal film as that of the first conductive film 42 which is constituted of the tungsten film and the aluminum film. The second light shielding film 46 is connected with the first conductive film 42 through the contact hole 42CH. In the contact hole 42CH, to establish the connection between the second light shielding film 46 and the first conductive film 42, the metal film which forms the first light shielding film 44 and the metal film which forms the second light shielding film 46 are laminated to each other.

By forming the first light shielding film 44 and the second light shielding film 46 using the conductive film, by forming the third interlayer film 45 between the first light shielding film 44 and the second light shielding film 46 using an insulation film (dielectric film), by supplying the pixel potential control signals to the first light shielding film 44, and by supplying the gray scale voltages to the second light shielding film 46, the pixel capacitance can be formed by the first light shielding film 44 and the second light shielding film 46. Further, taking the withstand voltage of the third interlayer film 45 with respect to the gray scale voltage and the increase of the capacitance by reducing the film thickness of the third interlayer film 45 into consideration, it is preferable to set the film thickness of the third interlayer film 45 to 150 nm to 450 nm. It is more preferable to set the film thickness of the third interlayer film 45 to approximately 300 nm.

Subsequently, FIG. 23 shows a state in which the transparent substrate 2 is overlapped to the driving circuit substrate 1. On the peripheral portion of the driving circuit substrate 1, the peripheral frame 11 is formed. The liquid crystal composition 3 is held in a space surrounded by the peripheral frame 11, the driving circuit substrate 1 and the transparent substrate 2. The sealing material 12 is applied to the outside of the peripheral frame 11 between the driving circuit substrate 1 and the transparent substrate 2 which are overlapped to each other. The driving circuit substrate 1 and the transparent substrate 2 are fixed to each other by adhesion using the sealing material 12 thus forming the liquid crystal panel 100. Numeral 13 indicates external connection terminals.

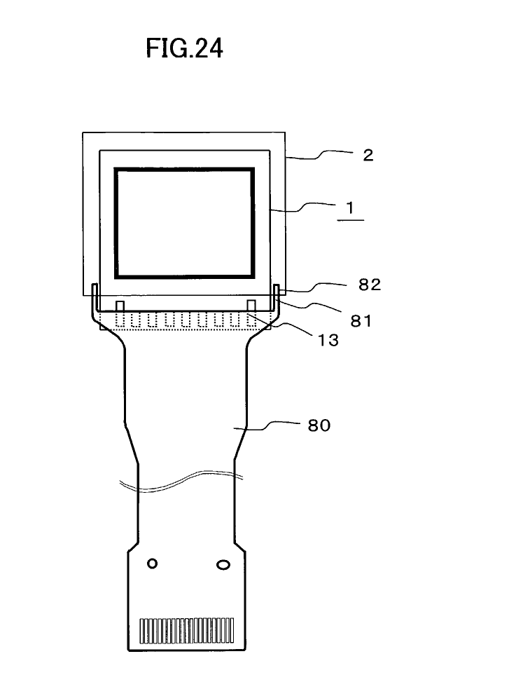

Subsequently, as shown in FIG. 24, a flexible printed wiring board 80 which supplies signals from the outside to the liquid crystal panel 100 is connected to the external connection terminals 13. Both outside terminals of the flexible printed wiring board 80 are formed in an elongated manner compared to other terminals and are connected to counter electrodes 6 formed on the transparent substrate 2 thus forming counter electrode terminals 81. That is, the flexible printed wiring board 80 is connected to both of the driving circuit substrate 1 and the transparent substrate 2. Here, FIG. 24 shows a state in which the flexible printed wiring board 80 is connected to the liquid crystal panel 100 shown in FIG. 4.

With respect to the conventional wiring to the counter electrodes 6, a flexible printed wiring board is connected to external connection terminals formed on the driving circuit substrate 1 and the flexible printed wiring board is connected to the counter electrodes 6 by way of the driving circuit substrate 1. To the transparent substrate 2 of this embodiment, a connection portion 82 with the flexible printed wiring board 80 is provided and hence, the flexible printed wiring board 80 is directly connected to the counter electrodes 6. That is, although the liquid crystal panel 100 is formed by overlapping the transparent substrate 2 and the driving circuit substrate 1, a portion of the transparent substrate 2 is projected to the outside of the driving circuit substrate 1 and forms the connection portion 82, and the transparent substrate 2 is connected with the flexible printed wiring board 80 through this outwardly-projected connection portion 82 of the transparent substrate 2.

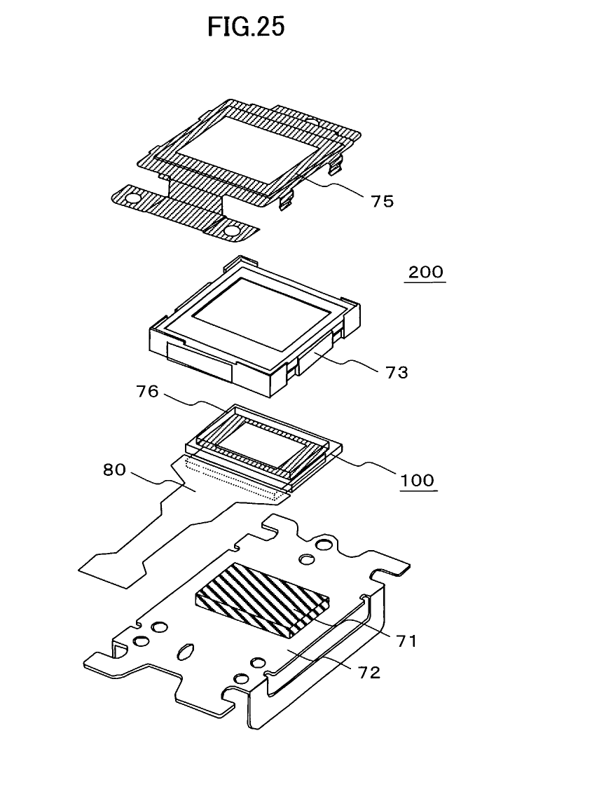

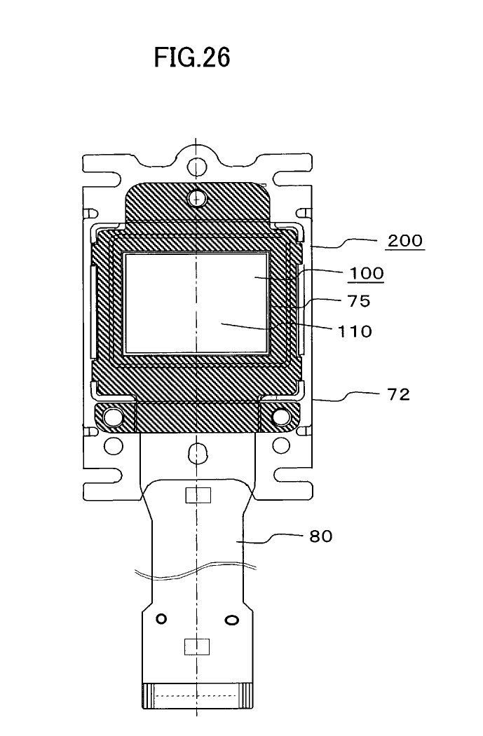

FIG. 25 and FIG. 26 show the constitution of the liquid crystal display device 200. FIG. 25 is an exploded assembly view of respective constitutional components which constitute the liquid crystal display device 200. Further, FIG. 26 is a plan view of the liquid crystal display device 200.

As shown in FIG. 25, the liquid crystal panel 100 to which the flexible printed wiring board 80 is connected is mounted on a heat dissipating plate 72 while sandwiching a heat sink compound 71 therebetween. The heat sink compound 71 is highly thermally conductive and fills a gap between the heat dissipating plate 72 and the liquid crystal panel 100 thus playing a role of facilitating the transfer of heat from the liquid crystal panel 100 to the heat dissipating plate 72. Numeral 73 indicates a mold which is served for fixing the heat dissipating plate 72 by adhesion.

Further, as shown in FIG. 25, the flexible printed wiring board 80 passes through between the mold 73 and the heat dissipating plate 72 and is taken to the outside of the mold 73. Numeral 75 indicates a light shielding plate which prevents light emitted from a light source from being incident on other components which constitute the liquid crystal display device 200. Numeral 76 indicates a light shielding frame which forms an outer frame of a display part 110 of the liquid crystal display device 200.

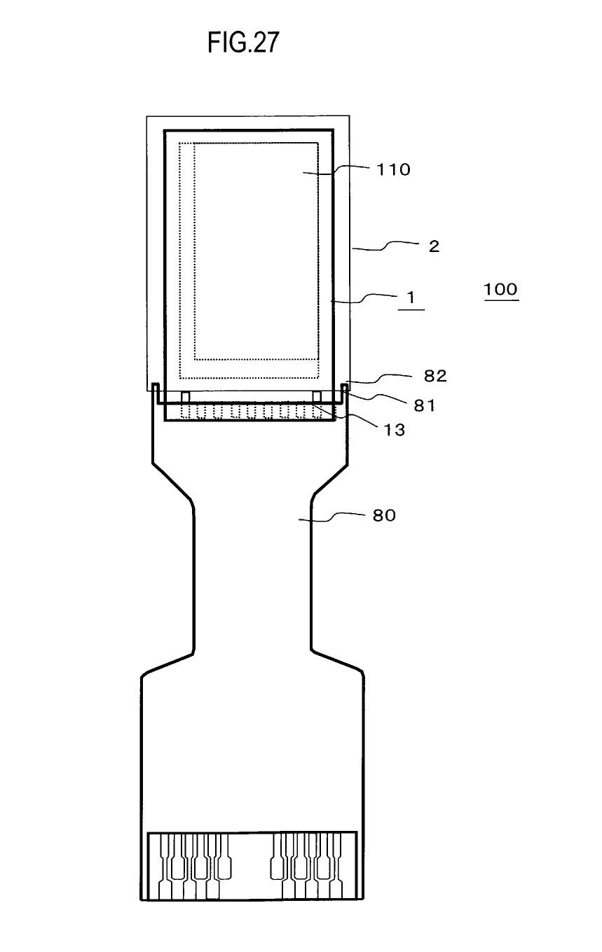

Subsequently, FIG. 27 shows a state in which the flexible printed wiring board 80 is connected to the liquid crystal panel 100 shown in FIG. 18. The flexible printed wiring board 80 is connected with the external connection terminals 13 of the liquid crystal panel 100. The display part 110 is formed such that the display part 110 is offset toward a right upper position in the drawing from the center of the liquid crystal panel 100. That is, the center of the display part 110 and the center of the liquid crystal panel 100 are not aligned with each other.

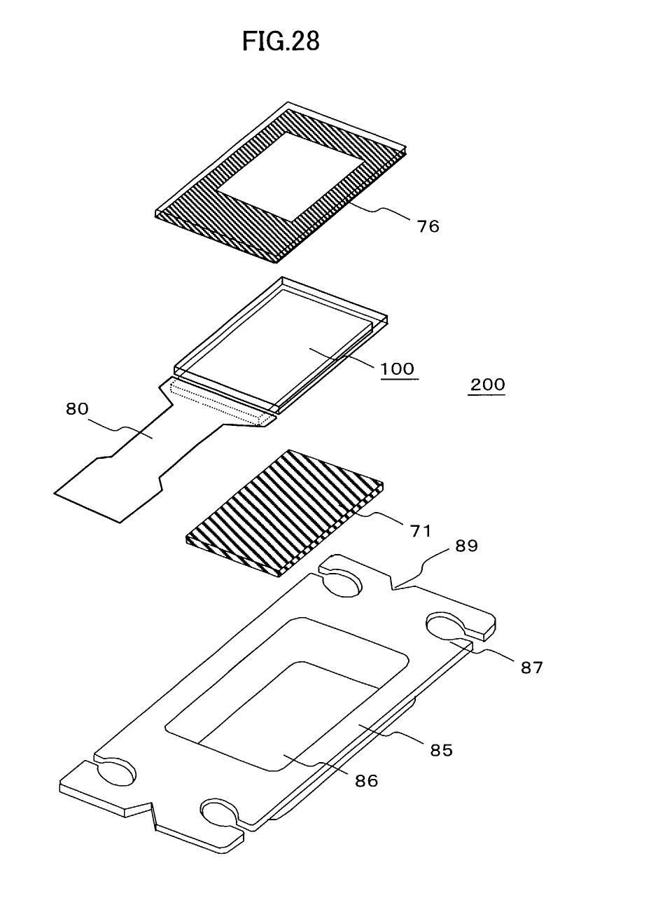

Subsequently, FIG. 28 shows an assembly state of the liquid crystal display device 200. In the drawing, numeral 85 indicates a package which is formed of a 42 alloy body covered with a Sn plating. A recessed portion 86 is formed in the package 85 and the liquid crystal panel 100 is housed in the inside of the recessed portion 86. Numeral 71 indicates a heat sink compound which has a role of transferring heat from the liquid crystal panel 100 to the package 85 for heat dissipation. Numeral 87 indicates mounting holes which are served for fixing the liquid crystal display device 200 to an external device. An opening is formed in the light shielding frame 76 corresponding to the display part 110. Numeral 89 indicates a contour reference groove which is served for indicating the reference of a contour size of the liquid crystal display device 200.

The manner of assembling the liquid crystal display device 200 is shown in FIG. 28. The flexible printed wiring board 80 is connected to the liquid crystal panel 100 to form a first pre-assembled body and, thereafter, the light shielding frame 76 is mounted on the first pre-assembled body to prepare a second pre-assembled body. Subsequently, the heat sink compound 71 is applied to the recessed portion 86 of the package 85. Thereafter, the liquid crystal panel 100 is mounted on the recessed portion 86 and, then, the light shielding frame 76 and the package 85 are adhered to each other using a flexible adhesive agent.

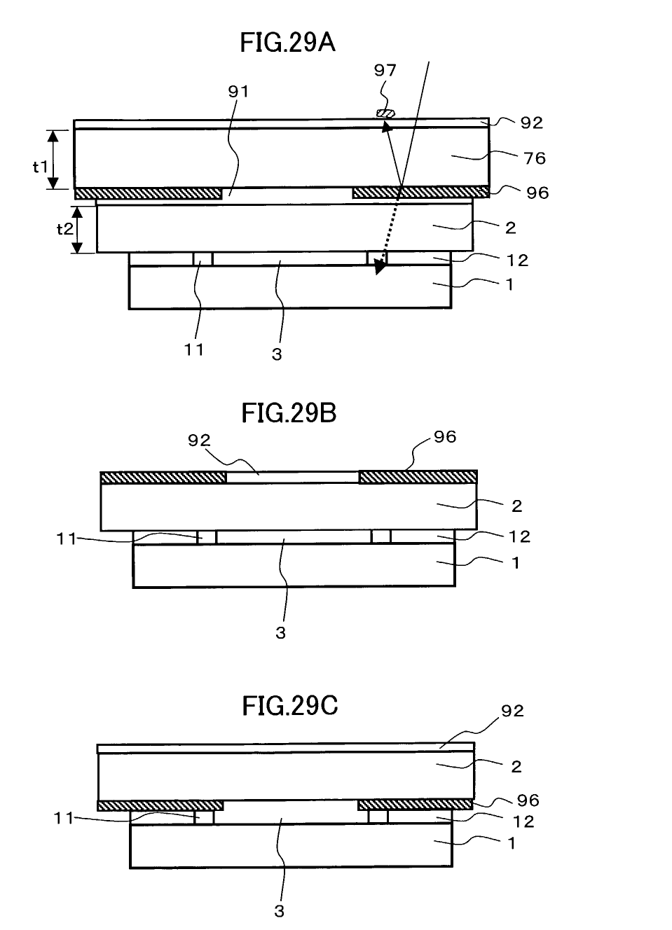

FIG. 29A shows a state in which the light shielding frame 76 is adhered to the liquid crystal panel 100. The light shielding frame 76 is served for preventing light from entering the outside of the display part 110. Unless the light shielding is provided to the outside of the display part 110, the outside of the display part 110 is reflected in the screen and hence, the display quality is degraded. Further the reflection also gives rise to the lowering of contrast. Still further, the light shielding frame 76 also prevents the peripheral frame 11 and the sealing material 12 from being deteriorated by light. A light shielding pattern 96 is formed on the light shielding frame 76 using a metal film made of Cr or the like. The light shielding pattern 96 consists of a type which reflects light like a mirror and of a low reflection (black) type which suppresses reflection. The mirror-like type light shielding pattern 96 reflects the light directly and exhibits the black display on the screen based on the principle of the display method shown in FIG. 13. On the other hand, the low reflective type light shielding pattern 96 suppresses the reflection by absorbing the light and exhibits the black display on the screen. Due to such provision of the light shielding pattern 96, it is possible to blacken the outer periphery of the display part (picture frame) so that a sharp image can be obtained. The light shielding frame 76 is formed of a transparent substrate made of glass, resin or the like and is adhered to the transparent substrate 2 using a transparent adhesive agent 91. On a front surface (upper side in the drawing) of the light shielding frame 76, a reflection prevention film 92 which is served for suppressing reflection is formed.

FIG. 29A shows the relationship of thickness between the light shielding frame 76 and the transparent substrate 2. The thickness t1 of the light shielding frame 76 is made different from the thickness t2 of the transparent substrate 2. By making the thickness t1 and the thickness t2 different from each other, even when a foreign material 97 adheres to the front surface of the light shielding pattern 96 of the light shielding frame 76, as indicated by an arrow in the drawing, a length of an optical path of light reflected on the foreign material 97 differs from a length of an optical path of light reflected on the substrate 1 (indicated by a dotted line in the drawing) (t1×2≠t1+t2) and hence, the foreign material 97 is defocused and is not apparent. This advantageous effect is particularly effective when the light shielding pattern 96 adopts the mirror type.

FIG. 29B shows a state in which the light shielding pattern 96 and the reflection prevention film 92 are directly formed on the transparent substrate 2. Since the light shielding frame is not constituted of a glass plate or the like, the possibility that a foreign material is sandwiched between the light shielding frame and the transparent substrate 2 can be reduced. FIG. 29C further shows a state in which the light shielding pattern 96 is interposed between the transparent substrate 2 and the substrate 1. Due to such a constitution, it is possible to omit an operation to laminate the light shielding frame to the liquid crystal panel 100.

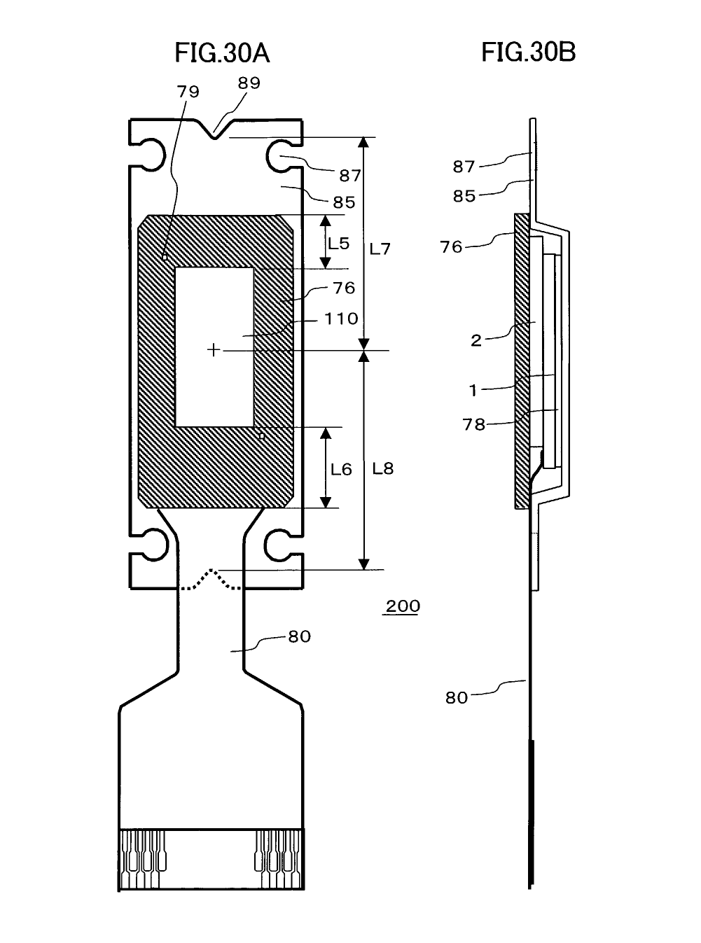

FIG. 30A is a schematic plan view of the liquid crystal display device 200 and FIG. 30B is a schematic cross-sectional view. Numeral 79 indicates a positioning mark used at the time of assembling. An opening is formed in the light shielding frame 76 to display the display part 110. Although the display part 110 is offset to the left upper side of the liquid crystal panel 100 in FIG. 27, the display part 110 is formed at a position where the left-and-right symmetry is obtained in the drawing with respect to the light shielding frame 76 in FIG. 30. However, with respect to the vertical direction or the upward-and-downward direction, to connect the flexible printed wiring board 80 to the liquid crystal panel 100 and to take out the flexible printed wiring board 80 to the outside of the light shielding frame 76, a length L6 of a lower side (side from which the flexible printed wiring board is taken out) of the light shielding frame 76 is set longer than a length L5 of an upper side of the light shielding frame 76. Here, respective distances L7 and L8 from the contour reference grooves 89 to the center of the display part 110 are set equal. That is, the center of the display part 110 and the center of the liquid crystal display device 200 are aligned with each other.

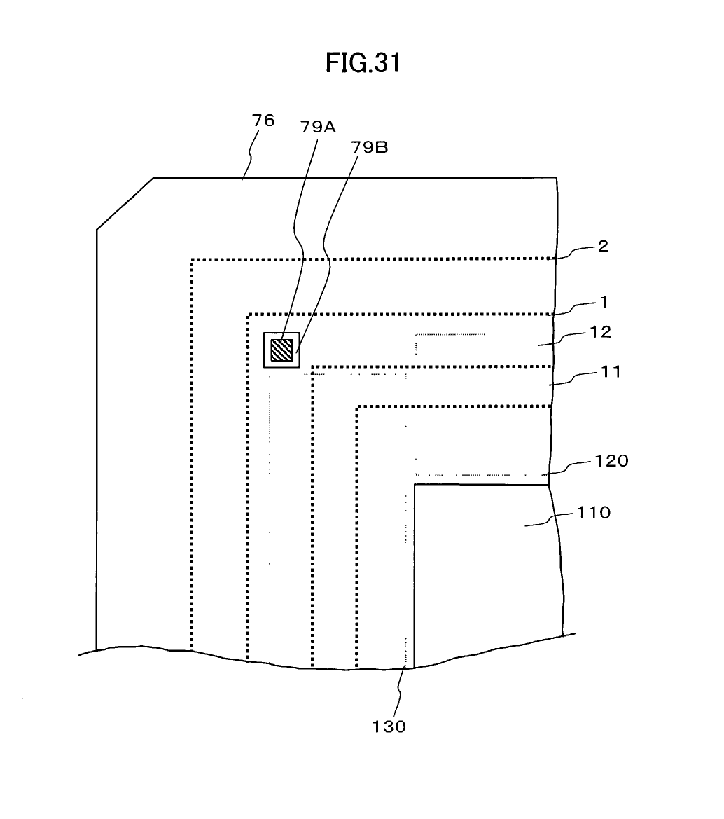

Subsequently, the positional relationship between positioning marks and the substrate 1, the transparent substrate 2 is explained in conjunction with FIG. 31. Numeral 79A indicates the positioning mark formed in the substrate 1 side and numeral 79B indicates the positioning mark formed in the light shielding frame side. A metal film or the like is formed on the light shielding frame 76 and hence, the light shielding frame 76 is opaque. Accordingly, to perform the positioning, it is necessary to form an opening such as the positioning mark 79B in the light shielding frame 76. The positioning mark 79A may be formed in the transparent substrate 2.

Although the light shielding frame 76 is formed along the display part 110, as mentioned previously, between the display part 110 and the peripheral frame 11, the region on which the liquid crystal composition is present is formed over the region where the horizontal driving circuit 120 and the vertical driving circuit 130 are formed. Further, the region where the driving circuit and the liquid crystal composition overlap each other is covered with the light shielding frame 76 so that the region is not observed.

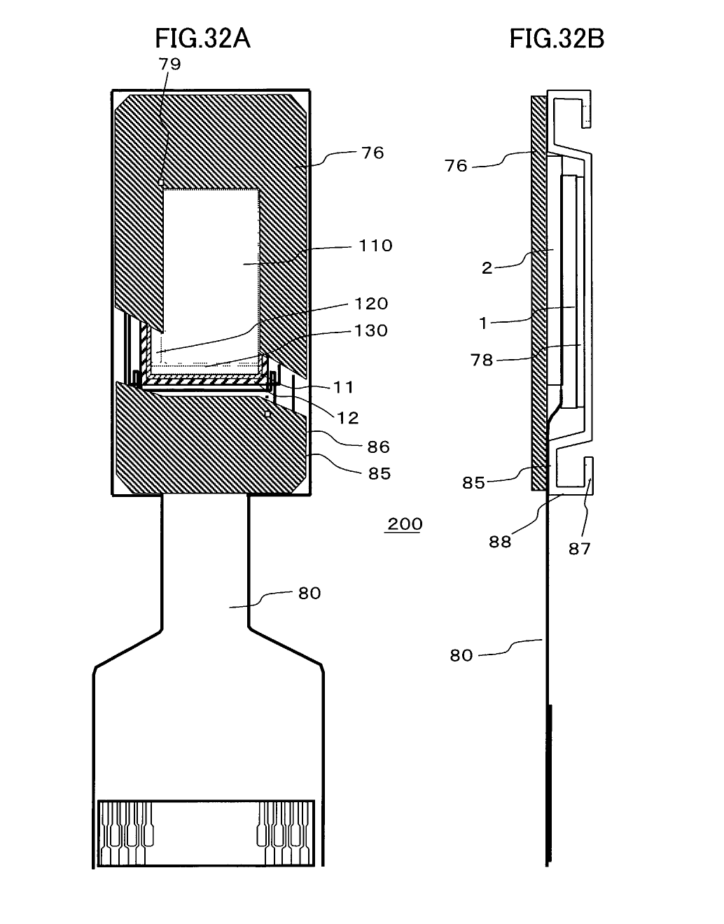

FIG. 32 shows the positional relationship among the light shielding frame 76, the horizontal driving circuit 120, the vertical driving circuit 130 and the like while omitting a portion of the light shielding frame 76. FIG. 32A is a schematic plan view of the liquid crystal display device 200 and FIG. 32B is a schematic cross-sectional view. To make the width of the region where the sealing material 12 is filled uniform, the display part 110 is formed such that the center of the display part 110 is offset from the center of the liquid crystal panel 100. Further, since the liquid crystal composition is present over the region where the driving circuits are formed, the region is covered with the light shielding frame 76 such that the region is not observed. In FIG. 32, a portion of the package 85 where the mounting holes 87 are formed is bent such that the mounting holes 87 are positioned at the same height or level with a bottom surface of the package 85. By forming the bent portion 88 on the package 85 and by setting the position of the mounting holes 87 at the bottom surface side, the mounting of the liquid crystal display device 200 is facilitated. Particularly, when the package 85 and the external device are connected to each other by soldering, it is possible to perform the soldering at the bottom surface side of the bent portion 88.

When providing the bent portion 88 and attaching to the external device at the bottom surface thereof, the whole liquid crystal display device can be covered by the shielding frame 76, the strong light can be incident on the liquid crystal display device 200.

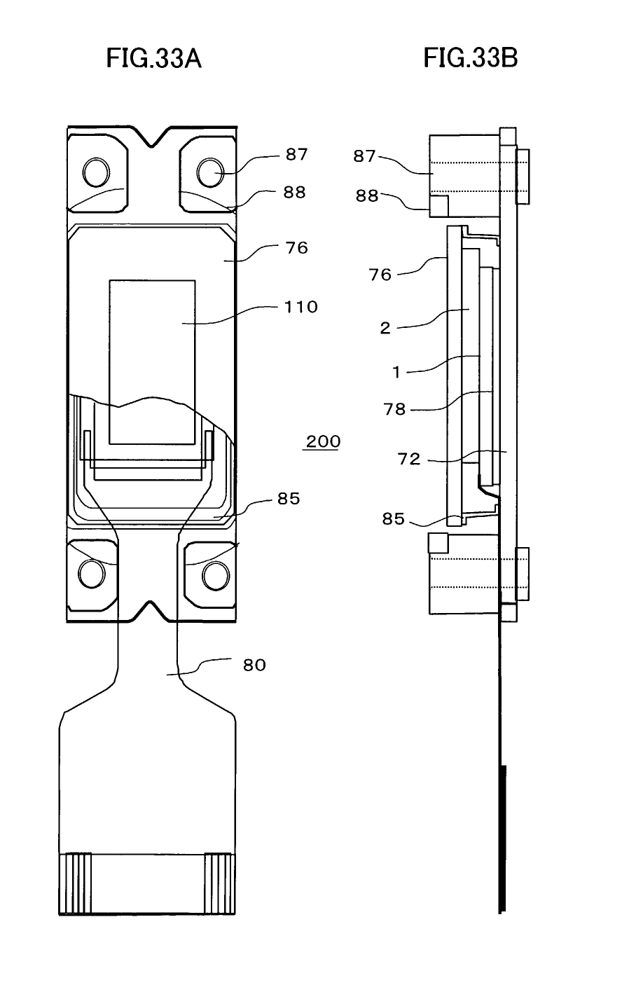

FIG. 33 shows the liquid crystal display device 200 in which the package 85 is formed in a frame shape and is adhered to the heat dissipating plate 72. FIG. 33A is a schematic plan view of the liquid crystal display device 200 and FIG. 33B is a schematic cross-sectional view. The flexible printed wiring board 80 is taken out to the outside after passing through between the package 85 and the heat dissipating plate 72. Numeral 88 indicates optical retardation plate mounting portions. The package 85 has a dish-like shape and has an opening in a bottom thereof. By forming the package 85 in a dish shape, it is possible to make the connection portion of the package 85 with the heat dissipating plate 72 spaced apart from an end portion of the heat dissipating plate 72. The heat dissipating plate 72 is formed of a metal plate or the like. Although the heat dissipating plate 72 exhibits the low flatness at the end portion thereof, by forming the package 85 in a disk-like shape, it is possible to prevent the package 85 from being connected to the end portion having the low flatness. Further, the heat dissipating plate 72 can be also miniaturized. Still further, the package 85 is covered with the light shielding frame 76 and hence, it is possible to prevent the strong light from being incident on the package 85.

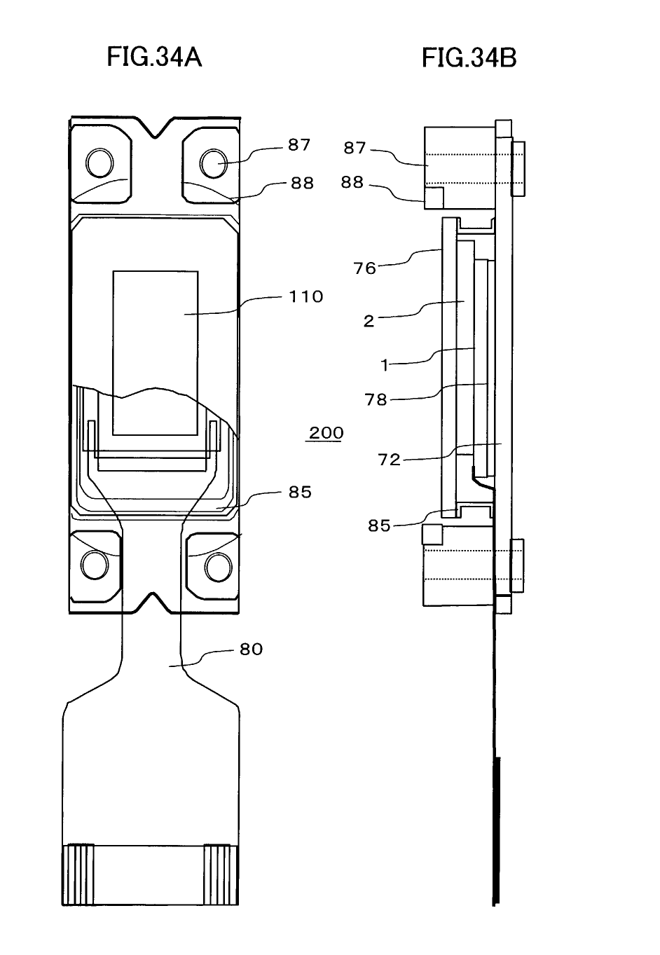

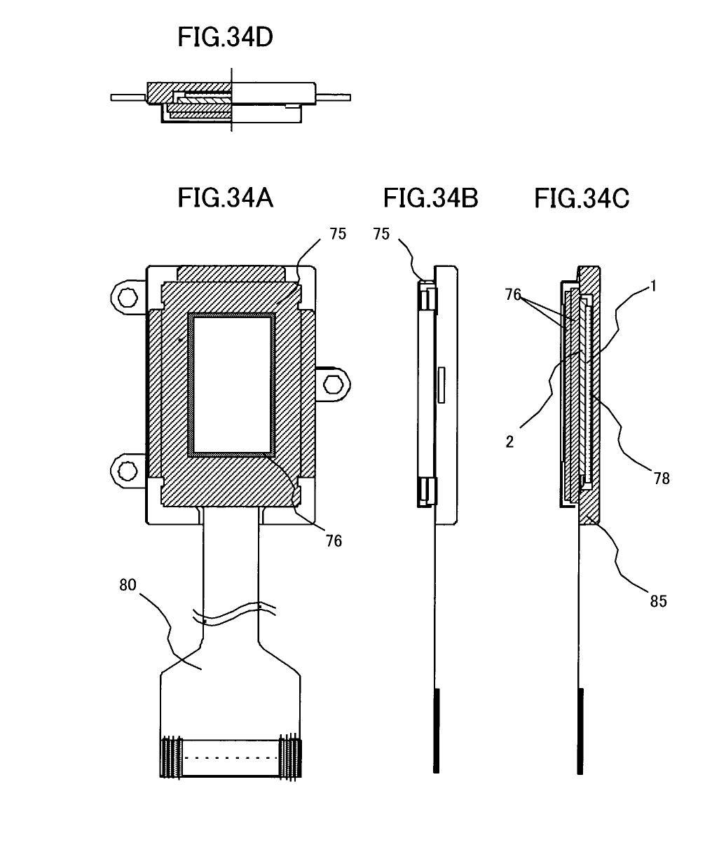

Then, FIG. 34 shows an embodiment in which the shape of the package 85 is changed. FIG. 34A is a schematic plan view of the liquid crystal display device 200 and FIG. 34B is a schematic cross-sectional view. The shape of the package 85 is configured such that the generation of stress can be suppressed. In the liquid crystal display device which adopts the electrically controlled birefringence mode, it is necessary to suppress the change of the gap d as much as possible. Further, in view of the fact that when stress is applied to glass, light generates birefringence in the inside of the glass so that the display quality is degraded due to luminance irregularities, the package 85 adopts the structure which prevents the deformation attributed to the stress from being applied to the liquid crystal panel 100. That is, by forming the package 85 using resin and by setting the thickness of the resin thin and uniform, the stress is alleviated or absorbed.

FIG. 35 shows an embodiment in which the shape of the package 85 is changed so as to mount a light shielding plate 75 on the package 85. FIG. 35A is a schematic plan view of the liquid crystal display device 200, FIG. 35B is a schematic side view, FIG. 35C is a schematic longitudinal cross-sectional view, and FIG. 35D is a schematic transverse cross-sectional view. The package 85 is made of metal such as Kovar or a 42 alloy which has the thermal expansion coefficient substantially equal to that of glass which is the material of the light shielding frame 76 or the transparent substrate 2 or that of silicon which is the material of the driving circuit substrate 1. Such metal is a material which can suppress the generation of stress due to the difference in thermal expansion coefficient and can easily dissipate the heat of the liquid crystal panel 100 to the outside. Further, Kovar and a 42 alloy are attracted to a magnetic material and hence, the package 85 is temporarily fixed to the liquid crystal display device 200 using a magnet at the time of assembling the package 85 into a projector so that the fine adjustment of positioning of the package 85 can be performed easily. The light shielding frame 76 has also a function of preventing the reflection of a dust on the screen by defocusing the dust when the dust is fixed to the surface of the screen. In this embodiment, to increase the thickness of the light shielding frame 76 thus increasing the defocusing effect, the light shielding frame 76 is constituted of a structure which is formed by laminating a glass plate on which the light shielding pattern 96 is formed and a glass plate on which a reflection prevention film 92 is formed to each other using a transparent adhesive agent 91. Further, the light shielding pattern 96 of the light shielding frame 76 is formed of a low-reflective type metal film.

When the light shielding pattern 96 of the low reflective type is adopted, a picture frame portion is blackened (darkened) compared to the mirror reflective type and a more sharpened display image can be obtained. However, the light shielding pattern 96 of low reflective type absorbs light and generates heat and hence, there arises the temperature difference between the inside of the light shielding frame 76 and the liquid crystal panel 100 and the stress is generated due to the expansion difference attributed to the temperature difference whereby the image quality is degraded including the increase of luminance irregularities. To cope with such a drawback, the light shielding plate 75 is provided. The light shielding plate 75 is molded using metal such as copper having a favorable heat conductivity or the like and a surface treatment such as black plating or the like is applied to a surface thereof for suppressing the reflection. As shown in FIG. 35A which constitutes the schematic plan view, the light shielding plate 75 covers the light shielding pattern 96 except for the display region 110 and a portion of the light shielding pattern 96 which surrounds the display region 110. Further, the light shielding plate 75 is configured such that the light shielding plate 75 is fixed to the package 85 and is not brought into contact with the light shielding frame 76. The light shielding plate 76 plays a role of preventing light from incident on the light shielding frame 76 more than necessary and efficiently dissipating the heat generated in the light shielding frame 76 to the package 85.

Although the inventions which have been made by the inventors have been specifically explained based on the above-mentioned embodiments, the present inventions are not limited to these embodiments of the present inventions and it is needless to say that various modification can be made without departing from the gist of the present inventions.

To briefly recapitulate the advantageous effects brought about by the typical inventions among the inventions disclosed in the present application, they are as follows.

According to the present inventions, even when the driving circuits arranged in the periphery of the display part are enlarged and the area in which these driving circuits are formed is enlarged, it is possible to uniformly apply the sealing material so that the reflective type liquid crystal display device which is highly reliable and is manufactured easily can be realized.

According to the present invention, it is possible to realize the miniaturized and highly reliable reflective type liquid crystal display device including the light shielding frame which performs the light shielding of the periphery of the display part.

What is claimed is:

1. A liquid crystal display device comprising:
a first substrate,
a second substrate,
a liquid crystal composition sandwiched between the first substrate and the second substrate,
a plurality of pixels formed above the first substrate in a matrix array,
a plurality of signal lines electrically connected with the pixels respectively,
a display region in which the pixel is formed and having four sides,
a first circuit formed upper side of the display region and electrically connected with the signal line,
a second circuit formed down side of the display region and electrically connected with the signal line,
a third circuit formed left side of the display region and electrically connected with the signal line,
a forth circuit formed right side of the display region and electrically connected with the signal line,
a peripheral frame which surrounds the display region and holds the liquid crystal composition in the inside thereof, and
a sealing region arranged outside of the peripheral frame and in which a sealing material is filled,
wherein, a first portion of the sealing region overlapped with the first circuit,
a second portion of the sealing region overlapped with the second circuit,
a third portion of the sealing region overlapped with the third circuit,
a fourth portion of the sealing region overlapped with the fourth circuit, and
a width of first, second, third and fourth portion are substantially equal length.

2. A liquid crystal display device according to claim 1, wherein said liquid crystal display device further includes a light shielding.

3. A liquid crystal display device according to claim 2, wherein said light shielding frame having positioning mark.

4. A liquid crystal display device comprising:
a liquid crystal panel,
a first substrate and a second substrate
a liquid crystal composition sandwiched between the first substrate and the second substrate,
a plurality of pixels formed on the first substrate in a matrix array,
a driving circuit supplying video signals to the pixels;
a display region on which the plurality of pixels are formed,
a peripheral frame surrounding the display region and holding the liquid crystal composition in the inside thereof;
a first region which constituting an inner region of the first substrate surrounded by the peripheral frame and in which the driving circuit is formed;
a second region arranged outside the peripheral frame and in which a sealing material is filled; and
a light shielding frame formed on the first substrate or the second substrate at a side from which light is incident and performing the light shielding of the first region and the second region.

5. A liquid crystal display device according to claim 1, wherein said light shielding frame having positioning mark.

6. A liquid crystal display device comprising:
a liquid crystal panel;
a first substrate and a second substrate which form the liquid crystal panel;
liquid crystal composition which is sandwiched between the first substrate and the second substrate;
a plurality of pixels which are formed on the first substrate in a matrix array;
a driving circuit which supplies video signals to the pixels;
a display region on which the plurality of pixels are formed;
a peripheral frame which surrounds the display region and holds the liquid crystal composition in the inside thereof;
a first region which constitutes an inner region of the first substrate surrounded by the peripheral frame and in which the driving circuit is formed;
a second region which is arranged outside the peripheral frame and in which a sealing material is filled;
a light shielding frame which is formed on the second substrate at a side from which light is incident and which performs the light shielding of the first region and second region; and
a package which includes an opening portion for housing the liquid crystal panel,
wherein the light shielding frame is configured to close the opening portion.

7. A liquid crystal display device according to claim 3,
wherein said liquid crystal display device further includes a light shielding plate formed on the light shielding frame at a side from which light is incident.

8. A liquid crystal display device according to claim 6, wherein said light shielding frame having positioning mark.
